(19) United States
(12) Patent Application Publication
(10) Pub. No.: US 2026/0289275 A1
(43) Pub. Date: Sep. 24, 2026

(54) SYSTEM

(71) Applicant: SoftBank Group Corp., Tokyo (JP)

(72) Inventor: Shuhei SUZUKI, Tokyo (JP)

(73) Assignee: SoftBank Group Corp., Tokyo (JP)

(21) Appl. No.: 19/567,291

(22) Filed: Mar. 16, 2026

(30) Foreign Application Priority Data
Mar. 19, 2025 (JP) 2025-045125

(51) Int. Cl. G06N 3/0475; G06F 40/205; G06F 40/295; G06F 40/40; G10L 25/63; G11B 27/031

(52) U.S. Cl. CPC G06N 3/0475; G06F 40/40; G11B 27/031; G06F 40/205; G06F 40/295; G10L 25/63

(57) ABSTRACT

A system includes a processor that is configured to receive video material, image material, and audio material prior to editing by using an input unit for receiving the material, receive information on a video to be generated by using an input unit for receiving the information, analyze the received material and the received information, generate a prompt for instructing automatic generation of a video by a generative AI model based on the analysis, and generate the video based on the prompt, and analyze a user emotion by using an emotion analysis unit and adjust content of the video based on a result of the analysis.

### CROSS-REFERENCE TO RELATED APPLICATION

This application is based on and claims priority under 35 USC 119 from Japanese Patent Application No. 2025-045125 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional video production workflows require a user to perform a large number of manual operations, including selection and arrangement of unedited video material, image material, and audio material, as well as detailed editing and adjustment of such material in accordance with an intended purpose and image of a final video. Even when generative AI models are employed, the user is typically required to manually design and input complex prompts, and it is difficult for a non-expert user to appropriately express the desired video content and style. Furthermore, conventional systems generally do not dynamically adjust the generated video based on the user's emotional reaction, and therefore cannot adequately reflect the user's emotional preference or satisfaction in the final video. In particular, in the case of short videos intended for public distribution on social platforms, conventional systems do not sufficiently automate optimization of required playback time, selection of cuts to be adopted, and style adjustment according to the user's emotional state. Accordingly, there is a need for a system capable of automatically generating a video by effectively utilizing generative AI models based on unedited material and abstract information on a video to be generated, while also analyzing user emotion and reflecting a result of the analysis in the generated video, without requiring the user to have specialized knowledge of video editing or AI prompt engineering.

### SUMMARY

In order to solve the above-described problems, according to one aspect of the present invention, there is provided a system comprising a processor, wherein the processor is configured to receive video material, image material, and audio material prior to editing by using an input unit for receiving the material, receive information on a video to be generated by using an input unit for receiving the information, analyze the received material and the received information, generate a prompt for instructing automatic generation of a video by a generative AI model based on the analysis, and generate the video based on the prompt, and analyze a user emotion by using an emotion analysis unit and adjust content of the video based on a result of the analysis. In another aspect, the processor is configured to, when publication of a short video is intended, analyze a required playback time and cuts to be adopted, generate a prompt for instructing generation of the video based on the analysis, and generate the video based on the prompt, thereby automatically generating a short video suitable for public distribution. In a further aspect, the processor is configured to interpret the received material and the received information by using artificial intelligence technology, generate a prompt for instructing automatic generation of the video by the generative AI model based on a result of the interpretation, and generate the video based on the prompt, whereby the user is relieved from the need to manually construct complex prompts and can obtain a video that reflects both the abstract intent for the video and the user's emotional response.

The term “system” refers to an apparatus including at least one processor and one or more functional units, such as an input unit and an emotion analysis unit, configured to execute the operations described in the claims.

The term “processor” refers to a hardware computing element, such as a CPU, GPU, ASIC, FPGA, or a combination thereof, capable of executing instructions to perform analysis, generation, and control processes described in the claims.

The term “input unit” refers to a hardware and/or software component configured to receive data from a user or an external device, including but not limited to user interfaces, network interfaces, file upload interfaces, or APIs for receiving material and information.

The term “video material” refers to digital data representing moving images prior to editing, including raw or partially processed video files containing one or more scenes.

The term “image material” refers to digital data representing still images prior to editing, including photographs, graphics, or other static visual content.

The term “audio material” refers to digital data representing sound prior to editing, including music, speech, sound effects, or ambient audio.

The term “information on a video to be generated” refers to abstract or concrete information related to a desired output video, including at least one of a purpose, concept, style, target length, target platform, or constraints specified by a user.

The term “analyze” refers to processing data to extract features, attributes, or semantic meaning, including but not limited to classification, detection, segmentation, recognition, or evaluation of the received material and information.

The term “interpret” refers to understanding and structuring the received material and information using artificial intelligence technology so as to derive intent, context, or relationships that can be used for controlling video generation.

The term “generative AI model” refers to a machine learning model configured to generate data, including video, image, audio, or text, based on an input such as a prompt, and including but not limited to deep learning models such as diffusion models, transformer models, or generative adversarial networks.

The term “prompt” refers to data including text, tokens, or structured parameters that specify instructions or conditions for controlling the behavior of a generative AI model in generating a video.

The term “automatic generation of a video” refers to the creation of at least a portion of a video by a generative AI model or by a system controlled by such a model, without requiring manual frame-by-frame or cut-by-cut editing by a user.

The term “emotion analysis unit” refers to a hardware and/or software component configured to estimate or classify a user's emotional state based on input data, including but not limited to facial expressions, voice, physiological signals, or interaction patterns.

The term “analyze a user emotion” refers to detecting or estimating an emotional state of a user, such as happiness, surprise, satisfaction, or disappointment, by applying emotion recognition algorithms or models to user-related data.

The term “adjust content of the video” refers to modifying at least one aspect of a video, including selection of scenes, duration, order of cuts, visual effects, text overlays, color tone, or audio, based on a result of emotion analysis or other analysis.

The term “short video” refers to a video having a relatively short playback time suitable for distribution on online platforms, including but not limited to videos of a duration specified by a user or constrained by a target service, such as tens of seconds.

The term “publication of a short video” refers to making a short video available to viewers via a distribution platform, including social media services, video sharing sites, or other online services.

The term “required playback time” refers to a target duration or allowable duration range for a video or short video specified by a user or determined based on a target platform.

The term “cuts to be adopted” refers to specific segments or portions of video material that are designated or selected to be included in a generated video.

The term “artificial intelligence technology” refers to computational techniques for performing tasks that typically require human intelligence, including but not limited to machine learning, deep learning, computer vision, natural language processing, and speech recognition.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

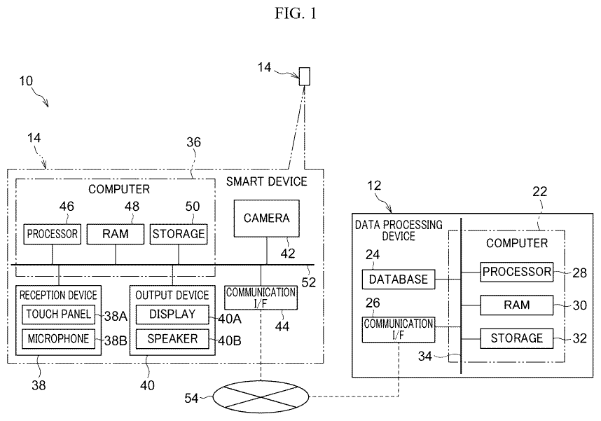

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

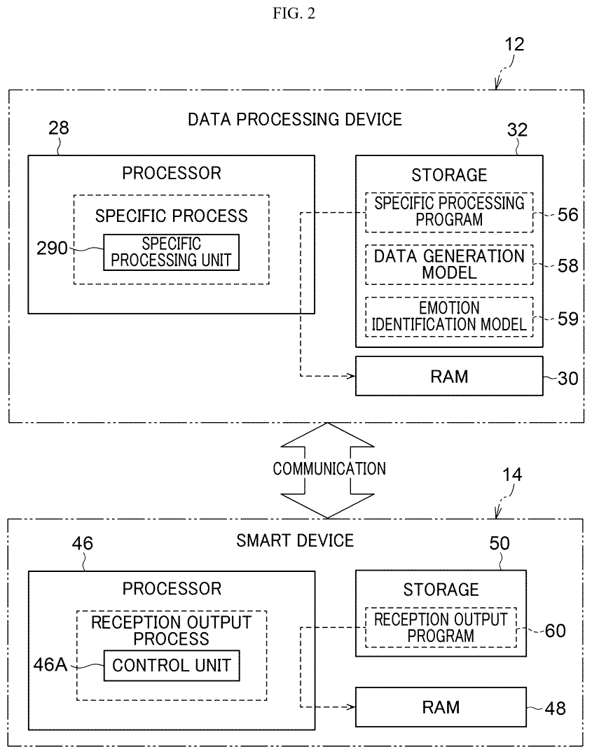

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented video editing and generation systems mainly provide tools for manual timeline editing or simple template-based composition. Such systems require a human editor to explicitly select scenes, determine an order of clips, adjust durations, apply transitions and color grading, and mix audio tracks. As a result, when non-expert users attempt to create short-form videos for publication, they must perform a large number of detailed operations in a graphical user interface, which is time-consuming, cognitively demanding, and prone to inconsistent quality.

Some recent systems attempt to use machine learning models to generate or edit video content. However, these systems generally treat a generative model as a black box that receives only a coarse textual instruction and outputs a video, without exploiting the rich structure of the input media and user context. In particular, typical systems do not: (i) systematically preprocess heterogeneous visual and auditory inputs into a unified internal representation optimized for a generative AI model, (ii) generate a model-specific prompt sentence that encodes a detailed editing policy including target duration, scene selection, transitions, visual tone, background sound, and caption placement, (iii) integrate user-specific emotional state signals to dynamically adapt the editing policy and prompt sentence, or (iv) automatically perform iterative refinement based on structured constraints derived from both media semantics and user reactions.

As a consequence, existing generative video systems often generate outputs that are poorly aligned with a user's intended purpose, target mood, and platform-specific constraints such as short playback duration. They also fail to reduce the computational and interaction overhead required to obtain a satisfactory result, because the user must repeatedly trial-and-error with vague prompts and manual re-editing. From the perspective of computer technology, these limitations lead to inefficient use of processing resources, sub-optimal orchestration between preprocessing modules and generative AI inference, and lack of a robust control layer that translates high-level user requirements and emotional feedback into precise machine-interpretable instructions.

Accordingly, there is a need for an improved computer-implemented technique that: (i) transforms raw heterogeneous media and abstract user requirements into a structured internal representation and a rich prompt sentence tailored to a generative AI model, (ii) automatically derives and enforces an editing policy compatible with short-form video constraints, and (iii) continuously adapts the policy and the prompt sentence based on user emotion estimation and interaction history. Such a technique should improve the functioning of the computer system itself by reducing redundant processing, providing more deterministic control over generative inference, and enabling efficient, repeatable generation of videos that better satisfy user intent.

The specific processing by the specific processing unit 290 of the data processing device 12 in Example 1 is realized by the following means.

The present invention provides a server comprising a processor configured to receive visual information and auditory information including multiple types of time information from a client device, store the visual information and the auditory information in a storage resource, acquire abstract feature information representing at least a purpose, an atmosphere, a target duration, focus scenes, and publication conditions for a desired video from a user, perform preprocessing on the visual information and the auditory information to extract time information, pixel information, acoustic information, and auxiliary information, convert at least a part of the auditory information into character information, and integrate the abstract feature information and the extracted information into an internal representation suitable for machine-learning processing, generate, based on the internal representation and the abstract feature information, an editing policy including at least a target playback duration, scenes to be adopted, an editing order, transition effects, color adjustment, background sound, and caption placement, generate a prompt sentence that encodes the editing policy as instruction content for a generative AI model, supply the prompt sentence and the internal representation to the generative AI model to cause the generative AI model to execute inference that automatically selects, splits, combines, processes, and synthesizes video content in accordance with the editing policy and outputs editing instruction information or composite video data, control an image-signal processing unit based on the editing instruction information to arrange the visual information and the auditory information on a time axis, apply transition effects, image-quality adjustments, and acoustic synthesis in accordance with the editing policy, and generate final video data, estimate an emotional state of the user based on at least one of biological information, operation-history information, and speech information of the user, dynamically modify at least a part of the prompt sentence or the editing policy in accordance with the emotional state, update video-generation processing performed by the generative AI model, and transmit the final video data to an external apparatus for playback, acquisition, and evaluation by the user. This enables an improved computer-implemented video generation workflow in which heterogeneous media inputs and user context are transformed into a structured internal representation and a model-optimized prompt sentence that precisely control generative AI inference, thereby reducing manual editing operations, improving utilization of processing resources, and producing short-form videos that more reliably satisfy user intent and platform constraints.

The term “visual information” refers to data representing images or image sequences, including still images and moving images, that are suitable for decoding and processing by an image signal processing unit or similar computational component.

The term “auditory information” refers to data representing sound, including speech signals, music signals, and environmental sounds, that are suitable for decoding and processing by an audio signal processing unit or similar computational component.

The term “time information” refers to information indicating temporal properties of visual information or auditory information, including at least timestamps, frame positions, playback time, segment boundaries, and duration values associated with portions of the information.

The term “storage unit” refers to any hardware and software combination configured to store data, including volatile and non-volatile memory, magnetic storage, optical storage, and solid-state storage, and logical structures such as databases and file systems implemented thereon.

The term “abstract feature information” refers to high-level descriptive information provided by a user or derived from user input, indicating at least a purpose, an atmosphere, a target duration, focus scenes, or publication conditions of a desired video, and which is not limited to low-level pixel values or sample values.

The term “purpose” refers to an intended use or objective of a generated video, including, for example, advertisement, entertainment, education, documentation, or social-media publication.

The term “atmosphere” refers to a qualitative impression or mood to be conveyed by a generated video, such as fun, calm, dynamic, emotional, or serious, which can be reflected in visual style and audio design.

The term “target duration” refers to a desired playback length for a generated video, specified as a time value or a range of time values to be enforced or approximated during editing and generation.

The term “focus scenes” refers to one or more portions of visual information or auditory information that are designated or inferred as important, and that are to be preferentially selected, emphasized, or preserved in the generated video.

The term “publication conditions” refers to constraints or requirements related to distribution or display of a generated video, including platform specifications, aspect ratio constraints, maximum file size, content policies, or audience type.

The term “preprocessing” refers to a series of computational operations performed prior to generative inference, including at least decoding, normalization, feature extraction, and format conversion, that transform raw visual information and auditory information into a form suitable for subsequent machine-learning-based processing.

The term “pixel information” refers to information derived from image samples of visual information, including pixel values, color components, spatial resolution, and features computed from such values, such as edges, textures, or embeddings.

The term “acoustic information” refers to information derived from sample values of auditory information, including amplitude, frequency components, spectral characteristics, loudness, pitch, and temporal features extracted from such samples.

The term “auxiliary information” refers to information associated with visual information or auditory information other than raw sample values, including metadata such as recording time, capture device settings, geolocation, file attributes, or automatically detected attributes such as object labels and scene types.

The term “character information” refers to symbolic text data obtained by converting auditory information, such as speech, into a sequence of characters, words, or tokens, and optionally including time alignment information between the text and the original auditory information.

The term “internal representation” refers to a structured data representation produced inside the server, which integrates abstract feature information and features extracted from visual information and auditory information, and which is optimized for processing by machine-learning models.

The term “editing policy” refers to a set of rules or parameters derived from the internal representation and the abstract feature information, specifying at least a target playback duration, scenes to be adopted, an editing order, transition effects, color adjustment, background sound, and caption placement for generating a video.

The term “scenes to be adopted” refers to one or more video segments or image intervals selected by the editing policy for inclusion in the generated video based on relevance, quality, or user preference.

The term “editing order” refers to an arrangement rule or sequence defining how selected scenes, images, and audio segments are temporally ordered or juxtaposed in the generated video.

The term “transition effects” refers to visual effects applied at boundaries between scenes or clips, including cross-fades, dissolves, wipes, zoom transitions, or other temporal visual transformations that smooth or stylize scene changes.

The term “color adjustment” refers to operations that modify color properties of visual information, including brightness, contrast, saturation, hue, tone mapping, and color grading, to achieve a desired visual style or atmosphere.

The term “background sound” refers to one or more audio elements, such as music or ambient noise, that are mixed with other audio tracks in a generated video to support the atmosphere or narrative.

The term “caption placement” refers to spatial and temporal positioning of text overlays, including subtitles, titles, or annotations, on video frames in accordance with layout rules and time alignment with audio or narrative content.

The term “prompt sentence” refers to a sequence of natural-language expressions, structured instructions, or a combination thereof, generated by the server to encode the editing policy and other control information as explicit input for a generative AI model.

The term “generative AI model” refers to a machine-learning model configured to generate or transform media content, such as video, image, audio, or text, in response to input data and a prompt sentence, and including but not limited to neural network models trained by supervised, unsupervised, or reinforcement learning methods.

The term “inference” refers to a computational process in which a trained generative AI model processes input data, including the internal representation and the prompt sentence, to produce output data such as editing instruction information or composite video data.

The term “editing instruction information” refers to structured information that describes how to construct a video from source media, including selection of segments, in-points and out-points, transitions, effects, and audio mixing parameters, and which can be executed or interpreted by an image-signal processing unit or similar component.

The term “composite video data” refers to video data generated by a generative AI model or by a rendering pipeline under control of editing instruction information, in which multiple media elements have been temporally and spatially combined into a single video stream.

The term “image-signal processing unit” refers to a hardware or software component, or a combination thereof, configured to process visual information according to editing instruction information, including operations such as cutting, concatenating, resizing, filtering, compositing, and encoding images or video frames.

The term “final video data” refers to video data output at the end of the generation process, which has been edited and rendered according to the editing policy and is suitable for playback, distribution, or storage.

The term “biological information” refers to information indicating physiological or biometric characteristics of a user, including heart rate, skin conductance, facial expression, eye movement, or other sensor-based measurements that can be used to infer an emotional state.

The term “operation-history information” refers to information about past interactions or inputs of a user with a system, including button presses, selection operations, playback controls, and modification actions, which can be analyzed to infer preferences or emotional reactions.

The term “speech information” refers to auditory information representing spoken utterances of a user, including both the acoustic waveform and any character information obtained by converting the speech into text.

The term “emotional state” refers to an estimate of a user's affective condition, such as satisfaction, dissatisfaction, excitement, boredom, or stress, inferred from at least one of biological information, operation-history information, and speech information.

The term “external apparatus” refers to any computing or display device external to the server, including client devices such as terminals, mobile devices, or display units, that are configured to receive, store, or reproduce final video data.

The term “client device” refers to a computing device used by a user to interact with the server, including but not limited to a smartphone, tablet, personal computer, or other network-connected terminal.

The term “server” refers to one or more computing devices, including a processor, a storage unit, and communication interfaces, configured to perform the preprocessing, prompt generation, generative AI control, editing, rendering, emotional state estimation, and transmission of final video data as described in the claims.

In one embodiment, a server cooperates with one or more terminals operated by a user to implement the claimed system. The server includes at least one processor, a main memory, a non-volatile storage device, a network interface, and an image-signal processing unit implemented in hardware, firmware, or software. The terminal includes a processor, a display, an input interface such as a touch panel or keyboard, local storage, and a communication interface. The user operates the terminal to supply media data and abstract feature information and to view generated video data.

The server executes an operating system such as a general-purpose server operating system and runs application software implementing modules for media preprocessing, feature extraction, prompt generation, generative AI model control, edit-instruction generation, rendering, emotional-state estimation, and communication with terminals. In one embodiment, the server implements the media preprocessing and rendering modules using a multimedia framework such as an FFmpeg-compatible library or a similar media processing framework capable of decoding and encoding video and audio streams. The server implements image analysis operations using an image-processing library such as a computer-vision toolkit, and audio analysis operations using an audio-signal processing library. The server implements natural-language processing components and the generative AI model using a machine-learning framework such as a tensor-based neural network library running on a graphics processing unit.

The terminal presents a graphical user interface to the user. The terminal displays file-selection controls allowing the user to choose unedited video files, still image files, and audio files stored on the terminal. The terminal also displays text input fields or selection widgets allowing the user to specify abstract feature information such as a purpose (for example, “social media post”), an atmosphere (for example, “fun and energetic”), a target duration (for example, “30 seconds”), focus scenes (for example, “city night view”), and publication conditions (for example, “vertical 9:16 format”). The user selects one or more media files and enters the abstract feature information in natural language, such as:

“Create a 30-second travel memory video with a bright and fun atmosphere. Prioritize scenes that show cityscapes and smiles. Apply colorful, high-contrast color grading, quick cuts synchronized to the beat of upbeat background music, and smooth zoom or slide transitions between key moments. Use this narration transcript as the main storytelling axis and align important visual scenes with the corresponding narration segments.”

In another example, the user enters:

“From the following interview video and audio materials, automatically create a 1-minute highlight reel with a calm and inspirational atmosphere. Select the most important quotes from the transcript and place them in logical order. Use slow cuts, gentle cross-fade transitions, and soft ambient background music at a low volume so that the speech remains clear. Avoid rapid motion and strong visual effects; keep the style simple and professional.” The terminal packages the selected media and the entered text and transmits them to the server via a network using a communication protocol such as HTTPS. The terminal may also transmit sensor information or interaction logs used later for estimating an emotional state of the user.

The server receives the visual information and auditory information as uploaded media files and stores them in a storage unit. The storage unit stores original media data and also stores metadata records in a structured database. The server assigns identifiers to each file and associates them with the current generation request. The server, rather than simply storing the files, performs structured preprocessing to transform heterogeneous media into an internal representation optimized for subsequent generative processing.

The server decodes video files using a video codec implementation in the multimedia framework. The server obtains raw video frames and associated time information such as frame indices and timestamps. The server computes pixel information such as spatial resolution, color histograms, motion vectors obtained by block-matching or optical-flow algorithms, and scene boundaries detected by frame-difference thresholds and histogram divergence. The server stores these features as numerical arrays indexed by time. The server also generates lower-resolution thumbnail sequences used by the generative AI model as visual tokens to reduce memory usage and increase processing speed.

The server analyzes still image files using an image-processing library. The server decodes image data into pixel arrays, normalizes orientation based on metadata, and resizes the arrays to a fixed spatial resolution for feature extraction. The server computes feature maps using a convolutional or transformer-based visual encoder. These feature maps form part of the internal representation. The server associates each image feature map with auxiliary information such as capture time or file metadata, enabling alignment with other media types. The server decodes audio files using an audio framework and converts them into waveform arrays with a standardized sampling rate and channel configuration. The server computes acoustic information including short-time Fourier transforms, mel-frequency cepstral coefficients, loudness curves, and estimated tempo. The server segments the audio into frames and detects speech regions versus non-speech regions using a voice-activity detection algorithm. The server then performs automatic speech recognition for the speech regions and produces character information as time-aligned transcripts. The server stores the transcripts and their time codes, creating a direct mapping between semantic content and original audio segments.

The server integrates the extracted pixel information, acoustic information, auxiliary information, and character information with the abstract feature information into a unified internal representation. In one embodiment, the internal representation takes a timeline-centric data structure, in which the server divides the media into uniform time slices and associates, for each time slice, multi-modal feature vectors representing video, audio, and textual content. The server also records higher-level segment units such as scene segments or sentence-aligned intervals for efficient selection by the generative AI model. This structured internal representation reduces the amount of raw media data that needs to be repeatedly scanned and enables the generative AI model to perform sequence reasoning using compact feature vectors rather than full-resolution frames and waveforms, thereby improving processing speed and memory efficiency.

The server analyzes the abstract feature information to derive an editing policy. The server uses a natural-language processing module implemented as a neural network encoder, such as a transformer encoder, to convert the user-supplied text into an embedding vector representing intent, mood, and constraints. The server then applies rule-based logic and learned classifiers on top of the embedding vector to extract explicit fields such as target duration, desired pacing (for example, “fast cuts” or “slow transitions”), color style (for example, “bright and saturated” versus “muted and soft”), and audio emphasis (for example, “music-driven” versus “speech-driven”). By combining these fields with statistics derived from the internal representation (for example, total duration of candidate scenes, distribution of smiles detected in frames, density of strong speech content), the server computes a set of parameters defining the editing policy.

The server generates a prompt sentence that explicitly encodes the editing policy and references the structure of the internal representation. Unlike a generic natural-language prompt, the prompt sentence produced here is a structured natural-language instruction that includes detailed constraints such as:

“Select approximately 30 seconds of content emphasizing segments where smiling faces are detected and cityscape scenes are present. Maintain an average shot length of 1 to 2 seconds. Apply bright, high-contrast color grading, insert zoom or slide transitions at shot boundaries, and align major visual changes with beats detected in the background music. Use the following narration transcript segments as anchors and align their time positions with visually relevant scenes.”

By generating such a detailed prompt sentence, the server provides the generative AI model with information that cannot be easily inferred from the raw user prompt alone. This increases determinism of the generative process and reduces the need for repeated trial-and-error interactions, thereby improving computational efficiency and user experience. The server controls a generative AI model implemented as a neural network architecture comprising modality-specific encoders and a sequence generator. In one embodiment, the generative AI model includes a visual encoder (for example, a stack of convolutional layers followed by a self-attention module) that takes thumbnail frames or image feature maps as input and outputs latent feature tokens; an audio encoder (for example, a convolutional or recurrent network that processes mel-spectrogram patches) that outputs audio tokens; and a text encoder (for example, a transformer layer) that processes character information and the prompt sentence. The model then uses a multimodal fusion transformer that concatenates or interleaves visual, audio, and text tokens along a time axis and applies self-attention with learned position encodings to produce a unified latent representation of candidate scenes. The generative AI model, as controlled by the server, produces either editing instruction information or composite video data. When generating editing instruction information, the model outputs, for each candidate segment, discrete decisions such as “include/exclude,” “start time,” “end time,” “transition type,” and “effect strength.” These outputs may be represented as sequences of tokens decoded by a transformer-based decoder trained to predict edit operations. The server interprets these tokens according to a predefined command grammar and converts them into a structured edit decision list. Because the output is structured, the server can efficiently apply it to original high-resolution media without repeatedly invoking the generative model.

In another embodiment, the generative AI model directly outputs composite video data in a lower-resolution format, which the server then upscales or re-encodes using an image-signal processing unit. In this case, the model implements a latent diffusion or autoregressive architecture that decodes fused latent tokens into video frames, and the server uses a hardware-accelerated encoder to convert the frames into a distribution-ready codec. The server may combine this directly generated content with portions of the original media using overlay and compositing operations, thereby preserving high-quality source information while still exploiting the generative capability.

The server then uses an image-signal processing unit to render final video data. The server reads the editing instruction information and applies it to the original media assets. The image-signal processing unit performs deterministic operations such as frame cropping, frame interpolation, color adjustment, overlay of captions, and insertion of transition effects according to numerical parameters supplied by the editing instruction information. The server uses audio-signal processing to mix background sound and original audio tracks according to calculated volume curves and cross-fade durations. These rendering operations are implemented as ordered pipelines of filters and compositors, and they are executed in a way that exploits hardware acceleration available on the server's graphics processing unit or dedicated video accelerator. By delegating generative decisions to the AI model and deterministic rendering to specialized media modules, the server reduces redundant computations and improves throughput compared with systems that repeatedly re-render entire timelines in an ad-hoc manner.

The server estimates an emotional state of the user based on biological information, operation-history information, and speech information. In one embodiment, the terminal captures face images and touch interaction logs while the user previews a generated video.

The terminal transmits anonymized facial expression features (for example, coordinates of facial landmarks and derived expression labels), timing of play/pause/skip operations, and optional voice comments to the server. The server processes these inputs using a separate neural network classifier trained to map combined features (for example, expression intensity, frequency of skips, sentiment of spoken feedback) to emotional categories such as “satisfied,” “confused,” or “bored.” The server stores the estimated emotional state and uses it as an additional input when regenerating the prompt sentence and editing policy.

For example, if the user frequently skips the first few seconds, the server interprets this as an indication that the introduction is too long. The server then updates the editing policy to reduce the allowed duration of the introduction segment and to select more engaging initial scenes. The server regenerates a prompt sentence such as:

“Shorten the introduction to approximately 3 seconds. Remove redundant establishing shots and begin with a dynamic scene showing close-up expressions. Maintain the overall duration near 30 seconds and preserve previously selected key scenes where strong emotional reactions were detected.”

The server supplies the updated prompt sentence and the existing internal representation to the generative AI model. Because the internal representation is already computed and stored, the server avoids redundant feature extraction. The generative AI model only needs to recompute edit decisions, not low-level features, leading to reduced processing time and improved responsiveness during iterative refinement.

This architecture produces technical effects beyond mere automation of manual editing. First, by constructing a timeline-centric internal representation and reusing it across multiple inference cycles, the server reduces computational cost and latency, improving processing speed for iterative video refinement. Second, by encoding an explicit editing policy into a structured prompt sentence and edit commands, the system improves the predictability and controllability of generative inference, reducing model variance and error rates in meeting target duration and content constraints. Third, by integrating user emotional state into the prompt generation and editing policy, the system adaptively tunes generative processing in a closed loop that the computer can execute autonomously, improving output relevance without requiring the user to specify low-level edits.

In one embodiment, the generative AI model is trained using supervised learning with paired examples of internal representations and target edit plans or videos. The server prepares training data by segmenting professionally edited videos into shot-level structures and extracting features similar to those computed at inference time. The server defines a loss function that combines multiple components, such as a cross-entropy loss for scene inclusion decisions, a regression loss for predicted durations and timing offsets, and a style-consistency loss for color and pacing attributes. The server performs weight updates using a gradient-based optimizer such as stochastic gradient descent with momentum or an adaptive learning-rate method. To improve robustness, the server performs data augmentation on visual features (for example, random cropping, slight color perturbation) and audio features (for example, noise injection, time stretching) while preserving alignment with annotations. As a result, the trained model can generalize to a wide range of user inputs and media types while maintaining accurate control over timing and style.

In another embodiment, the server uses reinforcement learning or preference-based fine-tuning, where the emotional state and explicit feedback of users serve as implicit reward signals. The server records pairs of generated videos and corresponding emotional reactions, and trains a reward model to predict user satisfaction. The server then adjusts the generative AI model or the prompt-generation strategy to maximize the predicted reward, further strengthening the coupling between computational decisions and real-world user responses. Alternative configurations are possible. The server may host multiple generative AI models specialized for different tasks, such as one model optimized for short-form social videos and another optimized for long-form documentaries. The server selects an appropriate model based on the abstract feature information and publication conditions. The server may also adjust the complexity of the internal representation by using more or fewer feature channels depending on processing resources and latency constraints, trading off absolute quality against responsiveness.

The terminal may be a smartphone, a tablet, a notebook computer, or a dedicated kiosk. In a smartphone embodiment, the terminal captures live video, still images, and audio recordings using built-in cameras and microphones, and transmits them directly to the server. In a desktop embodiment, the terminal may allow the user to import media from external storage and to preview multiple alternative generated videos side by side, with the user selecting a preferred version. In all cases, the terminal functions primarily as an input/output interface, while the server performs the heavy computational tasks of feature extraction, generative inference, and rendering.

By structuring data into an internal representation, by generating a model-optimized prompt sentence that expresses a detailed editing policy, and by controlling the generative AI model and image-signal processing unit according to that policy, the server improves the technical functioning of the computer system. The server reduces unnecessary recomputation, improves the accuracy of meeting specific playback and content constraints, and reduces memory footprint during inference by operating on compressed feature representations. The integration of emotional-state feedback further contributes to technical improvement by enabling the server to adapt its processing parameters based on actual usage patterns and physiological signals, leading to more efficient use of processing resources over time.

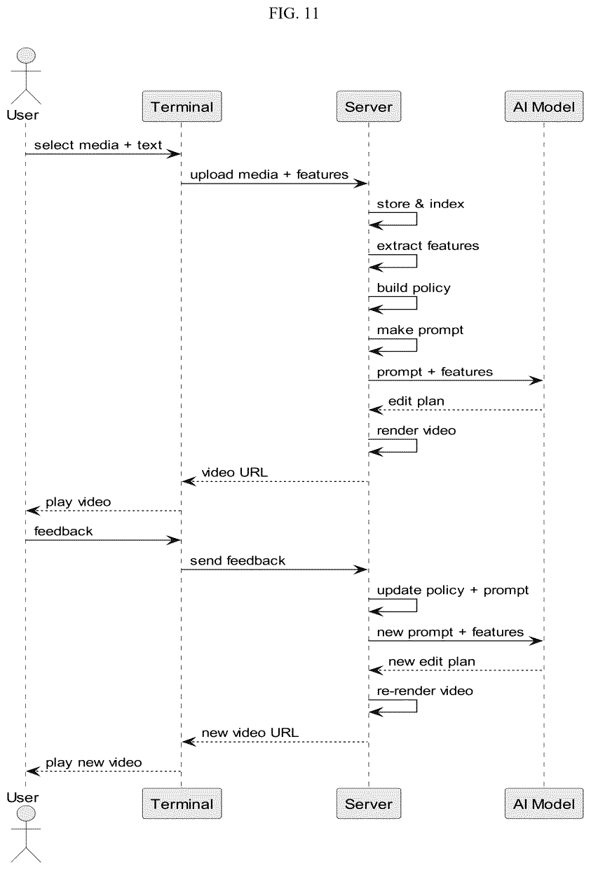

The following describes the processing flow using FIG. 11.

### Step 1:

The user operates the terminal to select media files and input abstract feature information.

The terminal displays a user interface that allows the user to choose unedited video files, image files, and audio files stored in local storage, and to enter a natural-language description of a desired video, including a purpose, an atmosphere, a target duration, focus scenes, and publication conditions. The input of this step is raw media data (files) and text typed or selected by the user. The terminal reads file paths and text strings, validates that at least one media file and feature description are provided, and outputs a structured request including file references and abstract feature information ready to be sent to the server.

### Step 2:

The terminal transmits the selected media and abstract feature information to the server.

The terminal packages the chosen media files into an upload request, for example using a multipart/form-data HTTP POST, and attaches metadata such as file name, media type, and user identifier. The terminal also serializes the abstract feature information into a text or structured payload (for example, JSON) and includes it in the same or a separate request. The input of this step is the structured request from Step 1; the terminal converts file contents into a binary stream and text fields into network packets. The output of this step is one or more network messages sent over a communication channel to the server.

### Step 3:

The server receives and stores the media data and abstract feature information.

The server accepts incoming HTTP requests, parses the multipart body, and writes each uploaded media file into a storage unit such as a file system or object store. The server assigns unique identifiers to the media files, records their paths, sizes, and types, and stores these attributes in a database. The server also parses the abstract feature information, normalizes character encoding, and stores the text along with references to the associated media identifiers. The input of this step is the network messages from the terminal; the server performs data parsing, ID assignment, and database insertion, and the output is a persistent record of media assets and feature information indexed by a request ID.

### Step 4:

The server decodes video files and extracts video features.

The server reads the stored video files using a multimedia framework and decodes them into raw frames and audio tracks. The server computes time information such as frame timestamps and total duration, and calculates pixel-level features including frame resolution, color histograms, edge density, and motion vectors obtained via optical-flow estimation or block matching. The server may perform scene-cut detection by comparing consecutive frames and marking large changes. The input of this step is raw compressed video files identified by media IDs; the server performs decoding and numerical analysis on pixel arrays, and the output is structured video feature data and time-aligned scene segments stored in the database or in an in-memory structure.

### Step 5:

The server processes image files and extracts image features.

The server opens each image file and decodes it into a pixel matrix. The server corrects orientation using metadata, rescales images to a standard resolution, and computes visual descriptors such as global color statistics, detected object labels, and embeddings produced by an image encoder network. The input of this step is raw image files; the server performs geometric transformations and feature extraction on pixel matrices, and the output is a set of image feature vectors and associated metadata such as capture time and aspect ratio.

### Step 6:

The server decodes audio files and computes acoustic features.

The server reads each audio file, decodes it to a waveform with a standardized sampling rate, and segments the waveform into frames. The server computes acoustic information including amplitude envelope, spectrograms, mel-spectrograms, and loudness profiles. The server may detect music versus speech segments using a classifier. The input of this step is compressed audio files; the server executes time-domain and frequency-domain signal processing on the waveform, and the output is frame-wise acoustic feature sequences and segment labels stored as numerical arrays with time indices.

### Step 7:

The server converts speech segments into character information.

The server applies a voice-activity detector to the acoustic features to identify intervals likely containing speech and passes these intervals to a speech-to-text engine. The server receives text transcripts with time codes and aligns them with the original audio timeline. The input of this step is the speech-labeled audio segments and their acoustic features; the server performs probabilistic decoding of phonetic states into character sequences, and the output is character information (text) with word- or sentence-level time stamps.

### Step 8:

The server constructs an internal multimodal representation.

The server aligns video features, image features, acoustic features, and character information on a common time axis. The server discretizes the overall media duration into time slices and aggregates, for each slice, the corresponding visual tokens, audio tokens, and text tokens into a unified feature vector. The server also registers higher-level segments such as shots or narrated sentences as composite nodes. The input of this step is the feature sets from Steps 4-7; the server executes temporal alignment, concatenation of feature vectors, and indexing operations, and the output is an internal representation data structure that compactly encodes all available media content for the request.

### Step 9:

The server interprets the abstract feature information to derive editing constraints.

The server feeds the user's abstract feature text into a natural-language encoder and produces an intent embedding. The server then applies classification and parsing logic to extract structured fields such as target duration, desired atmosphere, priority topics, pacing preference, and platform constraints. The server maps qualitative terms (for example, “short,” “energetic,” “calm”) to numeric ranges (for example, duration in seconds, average shot length, desired brightness). The input of this step is the stored abstract feature text; the server performs tokenization, embedding lookup, neural inference, and rule-based mapping, and the output is a set of editing constraints represented as parameter values.

### Step 10:

The server computes an editing policy from constraints and internal representation.

The server analyzes statistics of the internal representation, such as total available duration, distribution of facial expressions, density of significant speech segments, and diversity of scenes. Using the editing constraints, the server determines a feasible allocation of time to introduction, main content, and ending, and ranks candidate segments by relevance to the user's intent. The server creates an editing policy that specifies which kinds of segments to prioritize, what transitions to prefer, and how to adjust color and audio levels. The input of this step is the editing constraints from Step 9 and the internal representation from Step 8; the server executes ranking algorithms, duration calculations, and thresholding logic, and the output is a structured editing policy object.

### Step 11:

The server generates a detailed prompt sentence for the generative AI model.

The server composes a natural-language prompt sentence that encodes the editing policy and summarizes the available content. The server inserts explicit instructions regarding segment selection, target duration, transitions, color grading, background sound, and caption placement into the text. The input of this step is the editing policy object and summary statistics derived from the internal representation; the server performs text template filling, optional language-model rewriting, and formatting, and the output is a prompt sentence string ready to be passed to the generative AI model.

### Step 12:

The server prepares model inputs and invokes the generative AI model.

The server selects the subset of internal representation features required by the generative AI model, such as down-sampled visual tokens, audio tokens, and text tokens. The server packages these tokens together with the prompt sentence into an input structure compliant with the model's API. The server then sends this input to the generative AI model running on a processing unit such as a graphics processing unit and waits for inference results. The input of this step is the prompt sentence from Step 11 and the internal representation from Step 8; the server executes data selection, normalization, and serialization, and the output is an inference request transmitted to the generative AI model and, after computation, raw model outputs.

### Step 13:

The server receives and interprets editing instruction information from the generative AI model.

The server obtains the model's output, which may include sequences of tokens representing operations such as clip selection, in/out times, transition types, and effect parameters. The server decodes these tokens according to a predefined grammar and converts them into a machine-readable edit decision list. The input of this step is the raw output of the generative AI model; the server performs token decoding, syntax checking, and structure building, and the output is structured editing instruction information specifying how to construct the final video.

### Step 14:

The server renders final video data using the editing instruction information.

The server drives an image-signal processing unit and an audio-signal processing module to apply the edit decision list to the original media files. The server loads the specified segments, trims them to the indicated in/out times, applies transitions and color adjustments with specified parameters, overlays captions at designated positions and times, and mixes background sound with original audio. The input of this step is the editing instruction information from Step 13 and the original media assets from storage; the server performs deterministic pixel and sample processing, compositing, and encoding, and the output is final video data encoded in a target format and stored in the storage unit.

### Step 15:

The server estimates an emotional state of the user during or after preview.

The server receives, from the terminal, biological signals (if available), operation-history logs such as play, pause, and skip events, and any spoken comments recorded by the user. The server extracts features such as expression scores, interaction frequencies, and sentiment scores from the speech. The server applies an emotional-state classifier to these features to infer categories like satisfaction or dissatisfaction. The input of this step is sensor data and interaction logs; the server executes feature extraction and classifier inference, and the output is an estimated emotional state associated with the generated video.

### Step 16:

The server updates the editing policy and prompt sentence based on the emotional state.

The server compares the estimated emotional state with target satisfaction criteria. If the user appears unsatisfied or bored, the server adjusts parameters in the editing policy, such as shortening an introduction, increasing shot variety, or softening background music. The server then regenerates a revised prompt sentence that explicitly instructs the generative AI model to modify the previous edit, for example by removing low-impact segments or changing transitions. The input of this step is the emotional state from Step 15 and the original editing policy from Step 10; the server performs parameter adjustment and text generation, and the output is an updated editing policy and a new prompt sentence.

### Step 17:

The server refines the video by re-invoking the generative AI model.

The server reuses the existing internal representation and feeds it together with the updated prompt sentence to the generative AI model, omitting redundant feature extraction. The generative AI model returns revised editing instruction information, which the server again interprets and applies through the rendering pipeline to produce a refined version of the final video data. The input of this step is the updated prompt sentence and the previously constructed internal representation; the server performs another inference call and rendering pass, and the output is a new, refined final video file.

### Step 18:

The terminal retrieves and displays the final video for the user.

The terminal receives from the server a notification containing a location of the final video file and associated metadata such as duration and thumbnail. The terminal requests the video file via the network, decodes the stream, and renders it on the display with playback controls. The input of this step is the download URL and metadata sent by the server; the terminal executes network retrieval, media decoding, and user-interface rendering, and the output is visual and auditory presentation of the generated video to the user.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computerized video authoring environments, including non-linear editors and template-based automatic video creation tools, require substantial manual intervention by users and rely on static rule sets or templates. These conventional systems typically treat user-provided media assets and user preferences as simple parameters for template selection or filter application, without deeply interpreting the semantic content of the media or the user's intent. As a result, the systems often generate video content that does not accurately reflect a desired narrative, mood, or usage context, and require repeated manual revisions, which increases computation, bandwidth usage, and processing latency on both server and client devices.

Furthermore, conventional systems that employ machine learning generally run models in narrowly defined sub-tasks, such as scene detection or style transfer, and do not provide an integrated computational architecture that transforms heterogeneous user inputs-textual descriptions, video, image, audio, and user reaction signals-into a coherent end-to-end editing plan. Existing approaches do not expose to the underlying generative models a unified representation that combines multimodal feature information with structured prompt sentences, and therefore cannot fully leverage the generative models' capacity to optimize clip selection, sequencing, transitions, overlays, and audio mixing in a single, coherent operation.

In addition, known systems do not effectively incorporate real-time or iterative user emotion information into the computational pipeline that controls media generation. User interfaces may collect feedback (such as “like” or “dislike”), but such feedback is typically stored as metadata and not fed back into the editing logic or generative model execution. As a result, conventional systems are not able to dynamically adapt the generative process or the editing plan based on fine-grained, automatically inferred emotional states derived from sensor data, voice, or interaction history. This leads to a mismatch between the generated video content and the user's actual emotional state or evolving preferences and forces the user to manually reconfigure parameters or re-edit the output.

Moreover, traditional video generation workflows often handle pre-processing (format unification, compression), feature extraction (visual and audio analysis), prompt handling (interpretation of user requirements), model execution, and media rendering as loosely coupled modules. These modules typically exchange data in ad-hoc formats and are not orchestrated around a stable, machine-interpretable “editing plan” representation derived directly from the output of a generative AI model. This fragmented architecture contributes to inefficiencies in memory usage, duplicated computation, reduced throughput of server resources, and difficulty in scaling the system to handle large volumes of user jobs with consistent quality of results.

Therefore, there is a need for an improved computer-implemented system and method that (i) converts raw multimedia inputs into normalized, feature-rich representations suitable for direct consumption by a generative AI model, (ii) constructs and uses structured prompt sentences as machine-interpretable control instructions for such models, (iii) generates an explicit editing plan that centrally governs subsequent editing operations, and (iv) dynamically adjusts the prompt, the plan, and the rendering operations in response to automatically inferred user emotion, thereby improving the efficiency, adaptability, and quality of server-based video generation processing as a whole.

The specific processing by the specific processing unit 290 of the data processing device 12 in Application Example 1 is realized by the following means.

The present invention provides a server comprising a processor, wherein the processor is configured to receive moving image information, still image information, and audio information including unedited content as input materials via an information acquisition unit; to receive abstract request information from a user regarding a theme, a purpose, a mood, and a playback time of moving image information to be generated via an information input unit; to execute, by a media pre-processing unit, format determination and capacity determination on the moving image information, the still image information, and the audio information and to perform conversion processing and compression processing on the moving image information, the still image information, and the audio information so as to unify the moving image information, the still image information, and the audio information into a predetermined encoding format and a predetermined resolution; to generate, by a prompt generation unit, text information defining the theme, the purpose, the mood, and the playback time of the moving image information to be generated on the basis of the abstract request information received by the information input unit and to format the text information into a structured prompt sentence serving as an instruction sentence to a generative artificial intelligence model; to extract, by a feature generation unit, temporal information, pixel feature information, audio feature information, and feature information related to a scene type, a subject type, or an attention level from the moving image information, the still image information, and the audio information, to perform text embedding processing for converting the text information included in the prompt sentence into a numerical representation, and to construct the feature information and the numerical representation as input data for the generative artificial intelligence model; to execute, by a generative model execution unit, the generative artificial intelligence model using computation resources on the basis of the input data constructed by the feature generation unit and to output editing plan information including segment selection information for moving image sections, segment order information, screen transition effect information, text overlay information, and audio mixing parameter information; to convert, by a media editing unit, the editing plan information obtained by the generative model execution unit into editing instruction information and to perform trimming processing, concatenation processing, screen composition processing, screen effect processing, character information overlay processing, and audio synthesis processing on the moving image information, the still image information, and the audio information to generate moving image data in the predetermined encoding format; to acquire, by an emotion analysis unit, expression information, audio information, or operation history information related to the user and to estimate an emotional state of the user so as to detect the emotional state of the user; to dynamically change, by a dynamic adjustment unit, at least one of the prompt sentence, the editing plan information, and moving image generation processing in the media editing unit on the basis of the emotional state estimated by the emotion analysis unit and an output of the generative artificial intelligence model and to generate moving image data adapted to the emotional state of the user; and to provide, by a moving image providing unit, the generated moving image data to an information terminal via a communication path and to cause the information terminal to output the generated moving image data in a format that is capable of being reproduced or stored. This enables an integrated, computer-implemented pipeline that normalizes heterogeneous multimedia inputs, represents user intent as a structured prompt sentence, computes an explicit editing plan using a generative artificial intelligence model, and adaptively refines the plan and the resulting moving image data based on automatically inferred user emotion, thereby improving the technical performance, scalability, and adaptability of server-based automatic video generation.

The term “moving image information” refers to digital data representing time-varying visual content, including but not limited to video sequences composed of multiple image frames arranged along a temporal axis.

The term “still image information” refers to digital data representing static visual content, including but not limited to single image frames or photographs that do not change over time.

The term “audio information” refers to digital data representing sound, including but not limited to speech, music, ambient noise, and other acoustic signals associated with moving image information or still image information.

The term “unedited content” refers to moving image information, still image information, or audio information that has not been subjected to prior compositing, trimming, sequencing, or effect application for the purpose of creating a final edited work.

The term “information acquisition unit” refers to a functional unit implemented by hardware, software, or a combination thereof, which is configured to receive moving image information, still image information, and audio information from an external device, a storage medium, or a communication network.

The term “information input unit” refers to a functional unit implemented by hardware, software, or a combination thereof, which is configured to receive abstract request information or other control information directly or indirectly from a user via an input interface.

The term “abstract request information” refers to high-level, non-technical input provided by a user, including but not limited to desired themes, purposes, moods, playback durations, or styles of moving image information to be generated, without specifying detailed editing parameters.

The term “media pre-processing unit” refers to a functional unit implemented by hardware, software, or a combination thereof, which is configured to analyze, convert, and compress moving image information, still image information, and audio information to satisfy predetermined format or quality conditions.

The term “format determination” refers to a processing operation that inspects media data to identify properties such as file type, encoding scheme, resolution, frame rate, sampling rate, or bit depth.

The term “capacity determination” refers to a processing operation that evaluates resource-related properties of media data, such as file size, duration, bitrate, or storage requirements.

The term “conversion processing” refers to a processing operation that changes at least one property of media data, such as encoding format, resolution, frame rate, or sampling rate, to conform to a target specification.

The term “compression processing” refers to a processing operation that reduces the data size of media information, either losslessly or lossily, while attempting to preserve perceptual quality within predefined constraints.

The term “encoding format” refers to a digital encoding scheme used for representing media information, such as a video codec, an audio codec, or an image codec, together with associated container specifications.

The term “prompt generation unit” refers to a functional unit implemented by hardware, software, or a combination thereof, which is configured to generate text information and to construct a structured prompt sentence for controlling a generative artificial intelligence model.

The term “text information” refers to a sequence of characters, tokens, or symbols representing semantic content in a natural language or structured language format.

The term “prompt sentence” refers to a structured text information instance that expresses instructions, constraints, or desired characteristics for controlling the behavior of a generative artificial intelligence model.

The term “instruction sentence to a generative artificial intelligence model” refers to a prompt sentence formatted such that a generative artificial intelligence model can interpret it as input that guides the generation of output data.

The term “feature generation unit” refers to a functional unit implemented by hardware, software, or a combination thereof, which is configured to extract numerical features from media information and to generate numerical representations of text information.

The term “temporal information” refers to information associated with time, including but not limited to timestamps, durations, frame indices, or timing positions of segments within moving image information or audio information.

The term “pixel feature information” refers to numerical descriptors derived from image pixels, including but not limited to color histograms, gradients, texture descriptors, edge information, or learned feature vectors.

The term “audio feature information” refers to numerical descriptors derived from audio signals, including but not limited to energy, spectral coefficients, pitch, timbre descriptors, beat positions, or learned feature vectors.

The term “scene type” refers to a classification category of a visual scene, such as indoor, outdoor, landscape, urban, or other semantic categories inferred from moving image information or still image information.

The term “subject type” refers to a classification category of a primary object or entity depicted in visual content, such as a person, an animal, a vehicle, or a specific object class.

The term “attention level” refers to a quantitative or qualitative measure indicating the relative importance, saliency, or visual prominence of a region, object, or time segment within media information.

The term “text embedding processing” refers to a computation that converts text information into one or more numerical vectors, typically by applying a neural network or other mathematical transformation.

The term “numerical representation” refers to a data structure composed of numerical values, such as vectors, matrices, or higher-dimensional tensors, that encodes semantic or structural information derived from input data.

The term “generative artificial intelligence model” refers to a machine learning model that is configured to generate new data, such as moving image information, editing plans, or other content, based on input data and learned parameters.

The term “generative model execution unit” refers to a functional unit implemented by hardware, software, or a combination thereof, which is configured to execute a generative artificial intelligence model using computation resources.

The term “computation resources” refers to processing components, memory components, or specialized hardware, including but not limited to central processing units, graphics processing units, or accelerators, used for executing numerical computations.

The term “editing plan information” refers to data describing a planned configuration for editing media information, including segment selection information, segment order information, screen transition effect information, text overlay information, and audio mixing parameter information.

The term “segment selection information” refers to data specifying which time intervals or portions of moving image information or audio information are to be included in a generated moving image.

The term “segment order information” refers to data specifying a sequence in which selected segments are to be arranged in time in the generated moving image.

The term “screen transition effect information” refers to data specifying temporal effects between adjacent visual segments, such as cuts, fades, dissolves, wipes, or other transition styles.

The term “text overlay information” refers to data specifying textual content, position, timing, style, and other parameters for superimposed text in a generated moving image.

The term “audio mixing parameter information” refers to data specifying relative levels, timing, panning, or other mixing characteristics of multiple audio sources in a generated audio track.

The term “media editing unit” refers to a functional unit implemented by hardware, software, or a combination thereof, which is configured to apply editing instruction information to media information to generate edited moving image data.

The term “editing instruction information” refers to machine-interpretable commands or parameters derived from editing plan information for controlling trimming, concatenation, composition, effects, overlay, and audio operations.

The term “trimming processing” refers to a processing operation that removes portions of media information before a start point or after an end point to restrict content to a specified time range.

The term “concatenation processing” refers to a processing operation that joins multiple media segments in sequence to form a continuous stream.

The term “screen composition processing” refers to a processing operation that combines multiple visual elements, such as layers, overlays, or picture-in-picture layouts, into a single output frame.

The term “screen effect processing” refers to a processing operation that applies visual transformations, such as transitions, color adjustments, filters, or motion effects, to image or video frames.

The term “character information overlay processing” refers to a processing operation that places text or symbolic characters over visual content at specified positions and times.

The term “audio synthesis processing” refers to a processing operation that combines, transforms, or otherwise generates audio signals, including mixing, applying effects, or generating new audio content.

The term “moving image data” refers to encoded digital data representing one or more edited or generated moving images suitable for playback or storage.

The term “emotion analysis unit” refers to a functional unit implemented by hardware, software, or a combination thereof, which is configured to acquire user-related information and to estimate an emotional state of the user.

The term “expression information” refers to data derived from a user's facial expressions, body posture, or other observable physical indicators captured by sensors or input devices.

The term “operation history information” refers to data representing past user interactions with a device or application, such as button presses, playback actions, selections, or editing operations.

The term “emotional state” refers to an inferred mental or affective condition of a user, such as happiness, sadness, excitement, calmness, or other emotion categories or levels.

The term “dynamic adjustment unit” refers to a functional unit implemented by hardware, software, or a combination thereof, which is configured to modify at least one of a prompt sentence, editing plan information, or media generation processing in response to an estimated emotional state or model output.

The term “moving image providing unit” refers to a functional unit implemented by hardware, software, or a combination thereof, which is configured to transmit generated moving image data to an external device via a communication path.

The term “information terminal” refers to an external device configured to receive, reproduce, or store digital content, including but not limited to a mobile device, a personal computer, or a display device.

The term “communication path” refers to a wired or wireless communication channel, network, or link used to transfer data between the server and an information terminal.

In one embodiment, a server implements the claimed system as a network-accessible video generation platform. The server comprises one or more processors, main memory, non-volatile storage, and at least one network interface. The server executes an operating system, such as a general-purpose server operating system, and runs application software including a web server module, an application server module, a media processing library, and a machine learning framework such as a tensor computation library. The server is communicatively connected to one or more terminals via a wired or wireless communication network.

A terminal is, for example, a smartphone, a tablet, or a personal computer that includes a processor, memory, a storage device, a display, a camera, a microphone, speakers, and a wireless or wired communication interface. The terminal executes an operating system, such as a mobile operating system or a desktop operating system, and runs a client application that communicates with the server. The user operates the terminal via a touch panel, a keyboard, or other input devices to supply media and textual information to the server and to receive generated moving image data.

The server implements an information acquisition unit by combining the web server module, the application server module, and storage access components. The information acquisition unit receives moving image information, still image information, and audio information uploaded by the terminal. The terminal stores user-captured content, such as videos recorded by a built-in camera and audio recorded by a built-in microphone, and the terminal transmits these items to the server via a secure communication protocol. The server writes the received media information to a file system or an object storage system and maintains an index of media identifiers and storage locations in a database.

The server implements an information input unit that receives abstract request information from the user via the terminal. The terminal displays input fields such as “Theme,”

“Purpose,” “Mood,” and “Desired Length” on its display, and the user types free-form natural language descriptions, such as:

“I want to create a short travel Vlog that feels like a professional video, with fast cuts and energetic background music.”

The terminal transmits this textual information to the server as character strings. The server stores the abstract request information in the database associated with the media identifiers for subsequent processing.

The server implements a media pre-processing unit using a media processing library, such as a command-line encoder/decoder toolkit and an image processing library. The media pre-processing unit performs format determination by reading container headers and codec identifiers of the received video, image, and audio data. The media pre-processing unit performs capacity determination by calculating each file's duration, resolution, frame rate, sampling rate, and data size.

When the received media are in heterogeneous formats, the server, via the media pre-processing unit, converts the media to a predetermined encoding format and resolution. For example, the server transcodes a high-resolution video from a first codec to a second codec at a target resolution such as 1920×1080 pixels, and converts an image from a first format to a second format. The server also compresses excessively large media by adjusting bitrates and compression parameters to limit data size. These conversion and compression operations are performed so that the downstream processing modules operate on a normalized media representation. This normalization reduces branching complexity in subsequent processing and improves cache locality and throughput of hardware acceleration units, thereby increasing the overall processing speed and reducing memory fragmentation on the server.

The server implements a prompt generation unit that constructs a prompt sentence to control a generative AI model. The prompt generation unit converts abstract request information, such as separate textual fields “Theme: summer trip,” “Mood: fun and energetic,” and “Length: about 60 seconds,” into a single coherent natural language instruction. For example, the prompt generation unit generates a prompt sentence:

“Using the uploaded travel videos and photos, generate a 45-60 second travel Vlog. Emphasize the most beautiful scenery, use dynamic camera cuts, apply smooth crossfade transitions, and synchronize cuts with the beat of the background music. The overall mood should be fun and energetic.”

The prompt generation unit may insert template phrases and constraint phrases to explicitly encode the user's intent in terms that can be mapped to model-controllable parameters. For instance, the prompt generation unit maps “short” to a numeric duration range, and maps “energetic” to a target tempo range and visual cut frequency.

The server implements a feature generation unit using an image processing library, an audio analysis library, and a machine learning framework. The feature generation unit loads normalized moving image information and still image information into memory as multi-dimensional arrays. The feature generation unit resizes frames to a standard resolution and converts color spaces to a standard representation. The feature generation unit then applies convolutional neural networks, implemented using a tensor computation library, to each frame to calculate pixel feature information such as intermediate feature maps. These feature maps capture texture, edges, and semantic entities such as faces or scenes.

The feature generation unit also analyzes audio information using an audio analysis library. The feature generation unit computes spectrograms, mel-frequency coefficients, and onset detection functions, and detects beat positions by identifying peaks in the onset functions. These computations provide audio feature information that numerically describes tempo, energy, and timbre.

The feature generation unit assigns scene type labels and subject type labels to frames by passing pixel feature information through a classification network. For example, the network assigns labels such as “beach,” “mountain,” or “city” as scene types, and “person,” “vehicle,” or “building” as subject types. The feature generation unit calculates attention level scores for each frame or time segment using a saliency model or a learned scoring function, such that segments with high visual interest or user-relevant content receive higher scores.

The feature generation unit performs text embedding processing on the prompt sentence, using a text encoder network such as a transformer-based model implemented in the same machine learning framework. The text encoder tokenizes the prompt sentence, maps tokens to embedding vectors, and applies multi-head self-attention and feed-forward layers to produce a fixed-length numerical representation of the prompt sentence. This numerical representation encodes the desired theme, purpose, mood, and temporal constraints in a vector space that is compatible with the downstream generative AI model.

The feature generation unit constructs a combined input data structure that includes: (i) temporal information such as timestamps and durations; (ii) pixel feature information for key frames or sampled frames; (iii) audio feature information such as beat positions and spectral features; (iv) scene type, subject type, and attention level features; and (v) the numerical representation of the prompt sentence. This combined input is organized as tensors with defined shapes, such as a sequence of segment descriptors where each descriptor includes multiple feature fields and is aligned with the text embedding through positional encodings. By structuring the data this way, the server enables the generative AI model to perform cross-modal reasoning between text, video, and audio in a single forward pass, which improves both the quality and computational efficiency of the generated editing plan compared to separate, loosely coupled heuristics.

The server implements a generative model execution unit that executes a generative AI model. In one embodiment, the generative AI model is a sequence-to-sequence or encoder-decoder neural network that takes as input the combined feature tensors and outputs editing plan information. The model architecture may include: an encoder that processes visual and audio features using stacked self-attention layers and feed-forward layers; a text encoder block that receives the prompt embedding; and a decoder that generates a sequence of editing tokens corresponding to segment selection, ordering, transitions, overlays, and audio mixing parameters.

The generative AI model is trained offline using supervised learning on a dataset of human-edited videos paired with original media and textual descriptions. During training, the server minimizes a loss function that includes cross-entropy loss over discrete editing decisions (such as cut points and transition types) and regression loss over continuous parameters (such as exact timing and volume levels). The server uses a gradient-based optimization algorithm to update model weights. The server may also apply data augmentation techniques such as random cropping of sequences, time-stretching of audio, and jittering of frame selection to improve model generalization. This training results in model parameters that capture non-trivial editing patterns and align them with textual descriptions and media features, providing a technical improvement over rule-based systems that cannot learn such patterns.

At inference time, the generative model execution unit loads the trained model weights into memory, possibly on a graphical computation device or another accelerator device, and performs batched tensor computations for multiple user jobs. The generative AI model processes the input tensors through multiple attention layers that jointly attend to text tokens and media segment features. The decoder outputs a sequence of editing tokens that represent editing plan information, including segment selection information (e.g., which parts of which source clips are used), segment order information (e.g., in which sequence segments are arranged), screen transition effect information (e.g., transitions between segments), text overlay information (e.g., titles, captions), and audio mixing parameter information (e.g., relative levels and fades). By employing this architecture, the server achieves improved computation efficiency by reusing shared encoder representations and reduces the number of passes needed to determine all editing decisions, leading to lower latency and fewer memory accesses compared to conventional modular pipelines.

The server implements a media editing unit that converts the editing plan information into editing instruction information and applies the instructions to media data. The media editing unit parses the editing tokens and maps them to concrete operations in the media processing library. For example, the media editing unit interprets a segment selection token as a pair of source file identifier and time interval, and generates a trimming command. The media editing unit interprets transition tokens as filter specifications, and text overlay tokens as commands with layout parameters.

The media editing unit then invokes the media processing library to execute trimming processing, concatenation processing, screen composition processing, screen effect processing, character information overlay processing, and audio synthesis processing. These operations are executed in a filter graph or pipeline that is optimized to minimize disk I/O and intermediate encoding steps. For instance, the media editing unit can configure in-memory pipes between filters and use hardware acceleration units when available. This integrated execution of editing operations reduces redundant decoding and encoding, thereby improving processing throughput and reducing power consumption on the server.

The server implements an emotion analysis unit that acquires user-related information and estimates an emotional state. The terminal may capture expression information using a camera and send it to the server as image sequences. The terminal may also send audio information captured by a microphone while the user previews content or provides voice feedback, and operation history information such as pause, rewind, or playback speed changes. The emotion analysis unit uses a dedicated neural network model, such as a convolutional-recurrent network or a transformer-based network, trained to map these signals to emotion categories or continuous emotion scores.

The emotion analysis unit converts input signals into feature vectors, for example by extracting facial landmarks, voice pitch contours, and temporal patterns of user interactions. The emotion analysis unit then applies the neural network to these features to produce an estimated emotional state, such as “highly satisfied,” “bored,” or “confused,” or numerical scores along dimensions such as arousal and valence. This detailed inference, performed on low-level sensor data and interaction traces, goes beyond simple user ratings and allows the system to adapt in near real time.

The server implements a dynamic adjustment unit that uses the estimated emotional state and the output of the generative AI model to adjust at least one of the prompt sentence, the editing plan information, and the media editing operations. For example, when the emotion analysis unit detects that the user appears bored during preview of a generated video, the dynamic adjustment unit can modify the prompt sentence internally to emphasize faster pacing, or can adjust the editing plan information by increasing the frequency of cuts and reducing the duration of low-attention segments. The dynamic adjustment unit may also modify audio mixing parameters to increase or decrease background music energy based on the user's emotional state.

To perform these adjustments, the dynamic adjustment unit applies algorithmic rules and learned mappings, such as rules that map emotion scores to target cut density or music loudness ranges. The dynamic adjustment unit can feed a modified prompt sentence back into the text encoder and rerun the generative AI model with updated constraints, or can apply post-processing on the editing plan tokens to swap out low-attention segments for higher-attention alternatives. This feedback loop enables the server to refine the generated moving image data without requiring the user to specify detailed editing commands, and results in improved alignment between user state and output content.

The server implements a moving image providing unit that delivers the final generated moving image data to the terminal. The moving image providing unit may generate multiple output bitstreams with different resolutions and bitrates for adaptive streaming. The server stores the generated moving image data in an output storage system and generates a playback address. The server then sends a response containing the playback address and metadata to the terminal.

The terminal receives the response and uses a media playback component to retrieve and render the moving image data. The terminal decodes the moving image data using hardware decoders and displays the video on its display while playing synchronized audio through its speakers or connected audio devices. The user thus experiences a video that has been algorithmically composed based on the user's media, textual intent, and inferred emotional state.

In a concrete example, the user captures several clips and photos during a city tour and uploads them from the terminal to the server. The user enters the following prompt sentence via the terminal:

“I want to create a short travel Vlog that feels like a professional YouTube video, with fast cuts and energetic background music.”

The server normalizes all uploaded clips to a unified format and resolution, extracts visual and audio features, constructs a numerical representation of the prompt sentence, and executes the generative AI model. The generative AI model outputs an editing plan that selects segments showing landmarks and crowd scenes, arranges them in a high-tempo sequence, applies crossfades at beat positions detected in audio, and overlays a title such as “City Highlights” at the beginning. The media editing unit renders the final moving image data according to this plan. If the emotion analysis unit later detects that the user's emotional state suggests that the video is too intense, the dynamic adjustment unit may reduce cut frequency and lower music volume in a revised version.

This architecture provides technical improvements beyond merely automating human editing decisions. By structuring multimedia inputs into normalized formats and unified feature tensors, the server reduces the complexity and overhead of heterogeneous processing, thereby improving processing speed and resource utilization. By defining and using a prompt sentence as a structured control surface for the generative AI model, the server enables consistent mapping from high-level user intent to low-level editing parameters, which improves prediction accuracy and reduces the need for repeated manual trial-and-error. By generating and applying an explicit editing plan representation, the server decouples high-level creative decisions from low-level rendering operations, enabling optimized pipeline execution and more predictable system performance. By integrating emotion analysis into the feedback loop, the server dynamically adjusts system behavior in a way that cannot be achieved by static templates or simple user ratings, reducing the number of iterations required to obtain satisfactory output and thus lowering communication and computation load.

Alternative embodiments may vary the specific model architectures, feature sets, or output formats while maintaining the same overall structure. For example, the generative AI model may be implemented as a diffusion-based generator that outputs frame-level compositions rather than editing tokens, or as a graph-based model that constructs a scene graph of segments and transitions. The feature generation unit may use different backbone networks for feature extraction, such as residual networks or vision transformers. The emotion analysis unit may utilize physiological sensors, such as heart rate sensors, instead of or in addition to visual and audio cues. The media editing unit may target different output formats, such as vertical video formats for specific applications.

In each embodiment, the server, the terminal, and the user cooperate through the described components and data structures so that the system as a whole achieves improved computational efficiency, accuracy, and adaptability in automatic video generation, while grounding the processing in specific hardware operations, software modules, and non-abstract data transformations.

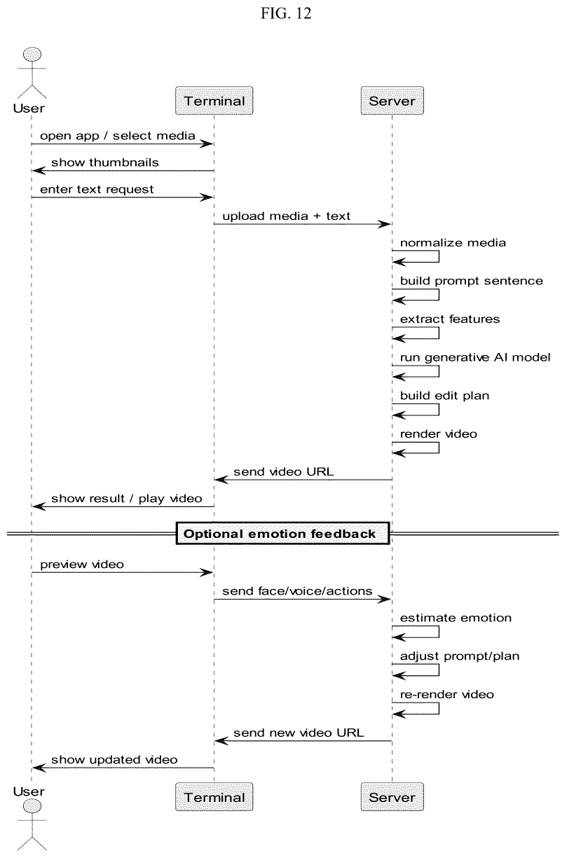

The following describes the processing flow using FIG. 12.

### Step 1:

The user operates the terminal to launch a dedicated video creation application and to select media materials.

The input of Step 1 is unedited moving image information, still image information, and audio information stored on the terminal.

The terminal displays thumbnails of videos, images, and audio tracks using its graphical user interface, and the user taps or clicks the desired items.

The terminal accesses a local storage subsystem, reads metadata such as file paths, durations, resolutions, and file sizes, and constructs an internal selection list.

The output of Step 1 is a structured selection list that associates each selected media item with its local path and basic metadata.

### Step 2:

The terminal validates and, if necessary, converts formats of the selected media items. The input of Step 2 is the structured selection list generated in Step 1.

The terminal calls media APIs and decoding libraries to read container headers and codec information of each file and determines whether each file matches a supported encoding format and resolution.

The terminal performs data processing by transcoding unsupported formats to target formats and resolutions, for example converting a high-resolution clip to a standard resolution and re-encoding audio to a supported codec.

The output of Step 2 is an updated media list in which each entry points to a media file stored in a normalized encoding format and resolution suitable for upload.

### Step 3:

The user operates the terminal to input abstract request information as free-form text.

The input of Step 3 is user intent in natural language, for example “I want to create a short travel Vlog that feels like a professional YouTube video, with fast cuts and energetic background music.”

The terminal presents text input fields such as “Theme,” “Purpose,” and “Mood,” and the user types or selects values.

The terminal concatenates the individual fields into a single raw text string and stores the string in application memory.

The output of Step 3 is a raw textual representation of the user's abstract request information.

### Step 4:

The terminal transmits the normalized media files and the raw textual request to the server.

The input of Step 4 is the updated media list and the raw text from Steps 2 and 3.

The terminal opens a network connection, constructs a request that includes the media files as binary payloads and the raw text as character data, and sends this request to the server via a communication interface.

The terminal applies data processing by segmenting file data into network packets and encoding the text using a character encoding scheme.

The output of Step 4 is a network message stream that conveys the media data and the text data to the server.

### Step 5:

The server receives the network message stream and stores media data and request data in storage systems.

The input of Step 5 is the incoming data stream produced in Step 4.

The server decodes the network protocol, extracts binary payloads as media files and text payloads as request strings, and writes the media files to a file system or object store.

The server performs data operations by generating unique identifiers, associating each identifier with a file location, and recording these mappings along with the raw textual request in a database record.

The output of Step 5 is a persisted job record that includes media identifiers, storage locations, and the textual request associated with a unique job ID.

### Step 6:

The server normalizes and pre-processes the media files to generate analysis-ready media streams.

The input of Step 6 is the job record with media identifiers and files stored in the storage system.

The server invokes a media processing library to read each media file, determine its current encoding format, and, if necessary, transcode it to the predetermined encoding format and resolution used by the system.

The server applies data processing by decoding original streams into raw frames and samples, resampling or resizing them to the target specifications, and re-encoding them into normalized files.

The output of Step 6 is a normalized media set in which all moving images, still images, and audio tracks meet predetermined format and resolution requirements and are linked to the job ID.

### Step 7:

The server generates a structured prompt sentence from the user's abstract request information.

The input of Step 7 is the raw textual request stored in the job record.

The server parses the text, optionally segments it into fields such as theme, mood, and length, and maps qualitative expressions (e.g., “short,” “energetic”) to internal parameters such as duration ranges and style tags.

The server performs data operations by combining fixed template phrases with the parsed content and encoded parameter values to construct a coherent prompt sentence, for example: “Using the uploaded travel videos and photos, generate a 45-60 second travel Vlog. Emphasize the most beautiful scenery, use dynamic camera cuts, apply smooth crossfade transitions, and synchronize cuts with the beat of the background music. The overall mood should be fun and energetic.”

The output of Step 7 is a single structured prompt sentence associated with the job ID.

### Step 8:

The server extracts visual features from moving image information and still image information.

The input of Step 8 is the normalized set of moving images and still images from Step 6.

The server loads video frames and still images into memory as arrays of pixel values and uses an image processing library to resize and normalize these arrays.

The server applies a convolutional neural network to each frame to compute intermediate feature maps; it then aggregates these feature maps over time to create segment-level feature vectors representing scene content, textures, and objects.

The output of Step 8 is a set of visual feature vectors and associated temporal metadata for each visual segment.

### Step 9:

The server extracts audio features from audio information aligned with the visual segments.

The input of Step 9 is the normalized audio tracks associated with the job.

The server decodes audio streams into time-domain samples, segments the samples according to corresponding video timestamps, and computes time-frequency representations such as spectrograms and mel-scale representations.

The server applies data processing to derive audio feature vectors, including beat positions, onset strengths, spectral centroids, and energy levels for each segment.

The output of Step 9 is a set of audio feature vectors and beat timing information aligned with segment times.

### Step 10:

The server assigns semantic labels and attention levels to segments based on visual and audio features.

The input of Step 10 is the visual and audio feature vectors from Steps 8 and 9.

The server feeds these feature vectors into classification networks that output probabilities over scene types and subject types, and into a scoring model that outputs attention level scores indicating visual or narrative importance.

The server performs data operations by selecting the most probable labels for scene type and subject type for each segment and by normalizing attention scores across the video to make them comparable.

The output of Step 10 is a semantic descriptor for each segment that includes scene type, subject type, and attention level, associated with their temporal positions.

### Step 11:

The server converts the structured prompt sentence into a numerical representation suitable for the generative AI model.

The input of Step 11 is the prompt sentence from Step 7.

The server tokenizes the prompt sentence into tokens, maps each token to an embedding vector using a learned embedding matrix, and passes the sequence of embeddings through a text encoder network with attention layers.

The server performs data calculations including matrix multiplications, non-linear activations, and attention weight computations to produce a fixed-length text embedding that encodes the semantics of the prompt sentence.

The output of Step 11 is a numerical vector or set of vectors representing the prompt sentence.

### Step 12:

The server constructs combined input tensors for the generative AI model.

The input of Step 12 is the segment descriptors from Step 10 and the text embedding from Step 11.

The server organizes visual feature vectors, audio feature vectors, scene and subject labels, attention scores, and temporal information into a sequence of segment feature tensors, and aligns this sequence with the text embedding using positional encodings or alignment indices.

The server applies data structuring operations by stacking, concatenating, and padding tensors to form a batch input with a defined shape that the generative AI model expects. The output of Step 12 is a set of input tensors containing multimodal features and the prompt embedding, ready for model execution.

### Step 13:

The server executes the generative AI model to produce editing plan information.

The input of Step 13 is the combined input tensors constructed in Step 12.

The server loads a pre-trained generative AI model into memory, optionally on an accelerator device, and feeds the input tensors through encoder and decoder layers that perform self-attention, cross-attention between text and media features, and feed-forward transformations.

The server calculates, for each decoding step, probabilities over editing operations and parameters, and samples or selects tokens that specify segment selection, segment ordering, transition types, text overlays, and audio mixing parameters.

The output of Step 13 is a sequence of editing tokens structured as editing plan information for the job.

### Step 14:

The server converts editing plan information into concrete editing instruction information.

The input of Step 14 is the editing plan information from Step 13.

The server parses the sequence of tokens to map abstract decisions, such as “select segment 3 from 5.0 to 7.5 seconds” or “insert crossfade between segments 4 and 5,” into explicit time ranges, source identifiers, and filter parameters.

The server performs data transformations by converting token values into numerical command arguments compatible with the media processing library, representing them in a data structure such as a filter graph specification.

The output of Step 14 is a complete set of editing instructions that specify trimming, concatenation, composition, transitions, text overlays, and audio mixing operations.

### Step 15:

The server renders the final moving image data by executing media editing operations.

The input of Step 15 is the editing instruction information from Step 14 and the normalized media from Step 6.

The server configures the media processing library with the specified trimming ranges, concatenation order, transition filters, overlay parameters, and audio mixes, and executes these as a pipeline.

The server performs data processing by decoding source media, applying transformations in the correct temporal order, mixing audio sources according to mixing parameters, and encoding the resulting stream into the predetermined output format.

The output of Step 15 is generated moving image data stored as one or more output files associated with the job ID.

### Step 16:

The server estimates the emotional state of the user based on user-related input signals.

The input of Step 16 is expression information, audio information, and operation history information transmitted by the terminal while the user previews or interacts with content.

The server converts raw signals into feature vectors, such as facial landmark coordinates, voice pitch contours, and timing statistics of play/pause/seek events, and applies an emotion recognition network to these features.

The server performs data calculations to output categorical emotion labels or continuous emotion scores, for example mapping feature patterns to a set of emotions or to numeric arousal and valence dimensions.

The output of Step 16 is an estimated emotional state associated with the user and the specific job.

### Step 17:

The server dynamically adjusts the prompt sentence, editing plan information, or editing operations based on the emotional state.

The input of Step 17 is the estimated emotional state from Step 16 and either the original prompt sentence, the editing plan information, or both.

The server applies predetermined rules or learned mappings to decide whether to regenerate the editing plan, to modify specific tokens, or to adjust parameters such as cut density or audio levels.

The server performs data processing by, for example, augmenting the prompt sentence to emphasize slower pacing when the user appears overwhelmed, re-encoding the prompt embedding, and re-executing the generative AI model, or by directly editing tokens in the existing editing plan to replace low-attention segments with higher-attention alternatives.

The output of Step 17 is an updated prompt sentence, modified editing plan information, or updated editing instructions that better match the user's emotional state.

### Step 18:

The server provides the generated moving image data to the terminal for playback or storage.

The input of Step 18 is the final generated moving image data from Step 15 (optionally revised using Step 17).

The server may create multiple encoded variants at different resolutions or bitrates and generate playback addresses for each. The server then composes a response message that includes these addresses and associated metadata.

The server performs data operations by writing the metadata to a database, formatting the response as a machine-readable document, and transmitting it over the communication path to the terminal.

The output of Step 18 is a response received by the terminal that enables the terminal to initiate retrieval and playback or storage of the generated moving image data.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented video authoring systems require human operators to manually interpret user requirements expressed in natural language, to translate such requirements into detailed timeline specifications, and to operate editing software to arrange and render audiovisual materials. Even when artificial intelligence components are used, they are often limited to content recommendation or template selection, and they do not generate machine-usable, fine-grained edit instructions that can be executed end-to-end by a computing system. As a result, there is significant latency and inconsistency between a user's intent and the rendered audiovisual output, and a large amount of manual intervention remains necessary, especially for short-form content that demands precise timing and structure.

Furthermore, existing systems typically treat user prompts as opaque text and rely on ad hoc scripts or rule-based engines to interpret such prompts, which leads to fragile behavior, poor scalability, and difficulty in adapting the system to new content types or distribution formats. The lack of a well-defined, machine-readable intermediate representation of edit instructions prevents the efficient orchestration of advanced editing operations, and constrains the ability of the system to reuse or refine previous editing plans based on additional user feedback. In addition, conventional systems do not deeply integrate emotion analysis information into the low-level editing pipeline. While some applications may use user feedback scores or basic reaction metrics, they do not systematically acquire and analyze user emotion data and do not feed the analysis results back into the generation of structural edit information. As a consequence, it is difficult for the system to computationally adjust cuts, pacing, visual effects, or audio design in a way that adapts to user emotion states, and to iteratively optimize the generated content without repeated manual re-editing.

There is therefore a need for an improved computer-implemented system that: (i) uses a generative AI model to transform a natural language prompt sentence and associated asset metadata into structured editing instruction data; (ii) converts such instruction data into an internal editing plan and into editing project data recognizable by an editing program, so that the editing program can be automatically driven to perform low-level digital signal processing on audiovisual data; and (iii) acquires and analyzes user emotion information and programmatically modifies editing instruction data or editing decision information based on the analysis, thereby closing the loop between user responses and system-level editing behavior. Such a system should improve the functioning of the computer itself by providing a new data processing architecture and control flow that reduces manual operations, improves determinism and repeatability of edits, and enables efficient generation and refinement of short-duration audiovisual content.

The specific processing by the specific processing unit 290 of the data processing device 12 in Example 2 is realized by the following means.

The present invention provides a server comprising a processor configured to receive unedited audiovisual data and information regarding audiovisual content to be generated, the information including a natural language prompt sentence, to control a generative artificial intelligence model so as to analyze the natural language prompt sentence together with attribute information of the audiovisual data and to output structured editing instruction data defining timeline configuration, segment boundaries, material assignments, and visual and auditory effects, to convert the structured editing instruction data into internal editing plan data and editing decision information including time and track arrangement information, to convert the editing decision information into editing project data recognizable by an editing program, to control the editing program using the editing project data so as to automatically execute digital signal processing on the audiovisual data and to generate audiovisual content data in a predetermined format, and to acquire information regarding a user's emotion and modify at least part of the structured editing instruction data or the editing decision information based on an analysis result of the user emotion information. This enables an improvement in computer technology by providing an end-to-end automated editing pipeline in which a generative AI model produces machine-readable edit specifications from natural language prompts, a server-side processor programmatically orchestrates an editing program at a low level through structured project data, and emotion-aware feedback is incorporated into the edit-planning data structures to computationally optimize the generated audiovisual content without manual intervention.

The term “audiovisual data” refers to digital data representing at least one of video information, image information, and audio information, which can be processed, edited, and rendered by a computing system.

The term “audiovisual content” refers to output data generated from audiovisual data, the output data comprising at least one sequence of video frames and, optionally, one or more synchronized audio tracks, suitable for playback on an information processing device.

The term “audiovisual content data” refers to a digital data file or data stream in a predetermined encoding format that embodies audiovisual content and that is generated by applying editing and rendering operations to audiovisual data.

The term “editing instruction data” refers to structured data that defines, in a machine-readable manner, at least a timeline configuration, segment boundaries, material assignments, and visual and auditory effects to be applied to audiovisual data by an editing process.

The term “internal editing plan data” refers to data stored in a memory of a computing device that represents an intermediate, system-specific plan for editing audiovisual data, the plan including associations between material identifiers and storage locations, and defining a basis for generating editing decision information and editing project data.

The term “editing decision information” refers to data that specifies, for each portion of audiovisual content to be generated, time information, track arrangement information, and selection and ordering of audiovisual data segments, and that is used to determine detailed editing operations to be executed.

The term “editing project data” refers to data having a format recognizable by an editing program, the data describing at least a timeline, media clip placements, transitions, effects, and text overlays, and being suitable for automatic loading and execution by the editing program.

The term “editing program” refers to software executed by a computing device that is capable of performing editing operations on audiovisual data, including at least cutting, arranging, applying transitions, adding visual or textual effects, and rendering the result into audiovisual content data.

The term “acquisition unit” refers to hardware, software, or a combination thereof, configured to receive or obtain data, such as audiovisual data or information regarding audiovisual content to be generated, from an external device, storage, or user interface.

The term “information regarding audiovisual content to be generated” refers to input information specifying desired characteristics of target audiovisual content, including at least duration, structure, and content elements, and including a natural language prompt sentence.

The term “natural language prompt sentence” refers to a sequence of natural language words or phrases provided by a user that describes, at a high level, desired properties, structure, or content of audiovisual content to be generated.

The term “generative artificial intelligence model” refers to a machine learning model, trained on data including natural language and optionally audiovisual metadata, that is configured to generate new data, including structured editing instruction data, based on input data such as a natural language prompt sentence and attribute information of audiovisual data.

The term “attribute information of the audiovisual data” refers to metadata associated with audiovisual data, including at least identifiers, file locations, durations, resolutions, aspect ratios, and data types, which are used by a computing system and a generative artificial intelligence model when generating editing instruction data.

The term “timeline configuration” refers to a specification of an arrangement of audiovisual segments along a time axis, including start times, end times, ordering, and concurrency of video and audio tracks.

The term “segment boundaries” refers to time positions on a timeline that define the start and end points of segments in audiovisual content.

The term “material assignments” refers to associations between specific audiovisual data items and specific timeline segments or tracks in an editing plan.

The term “visual and auditory effects” refers to processing operations applied to video and audio signals, including but not limited to transitions, filters, overlays, volume changes, and spatial or temporal modifications, to alter the appearance or sound of audiovisual content.

The term “track arrangement information” refers to data specifying the placement and layering of multiple audio and video tracks on a timeline, including which track is above or below another and which media elements are associated with each track.

The term “clipping processing” refers to an operation that cuts or trims audiovisual data by selecting a portion of the data between a start time and an end time.

The term “concatenation processing” refers to an operation that connects two or more audiovisual segments sequentially in time to form a continuous sequence.

The term “scene transition processing” refers to an operation that defines and applies a change from one visual scene to another, including cuts, dissolves, wipes, and other transition effects.

The term “character information superimposition processing” refers to an operation that overlays textual or symbolic information onto video frames, including positioning, styling, and timing of such overlays.

The term “audio synthesis processing” refers to an operation that generates or combines audio signals, including mixing multiple sound sources, generating synthetic sound, or applying effects to produce a desired audio result.

The term “character information rendering processing” refers to an operation that converts textual data into graphical form and draws the resulting characters within video frames, according to specified visual styles and positions.

The term “audio signal processing” refers to an operation that modifies audio data, including at least filtering, equalization, volume adjustment, panning, and application of temporal or spectral effects.

The term “digital signal processing” refers to computational operations applied to digital representations of audio or video signals, including at least clipping, transition application, filtering, mixing, and compositing, to generate modified audiovisual content.

The term “access information for the audiovisual content data” refers to information enabling retrieval or playback of audiovisual content data, including at least a resource identifier, a file path, or a network address usable by an information processing terminal.

The term “information processing terminal” refers to an electronic device including at least a processor, a memory, a communication interface, and a display or audio output, configured to receive audiovisual content data through a communication network and to present the content to a user.

The term “communication network” refers to a wired or wireless data communication infrastructure, including local area networks and wide area networks, through which data is transmitted between the server and one or more information processing terminals.

The term “user's emotion information” refers to data indicative of an emotional state of a user, obtained directly or indirectly, including but not limited to physiological signals, facial expressions, voice characteristics, behavioral logs, or explicit user input regarding emotions.

The term “emotion analysis algorithm” refers to a computational procedure or model configured to analyze user's emotion information and to output an analysis result representing at least one emotional state or intensity.

The term “analysis result of the emotion analysis algorithm” refers to output data produced by an emotion analysis algorithm, describing detected emotional states, such as satisfaction, interest, or engagement, and optionally including confidence measures or temporal variations of such states.

The term “editing project data recognizable by an editing program” refers to project data structured according to a predefined format that an editing program can parse and interpret to reconstruct a timeline, media references, effects, and other edit parameters without manual input.

The term “structured data” refers to data organized according to a defined schema, such as key-value pairs, tables, or hierarchical objects, which specify elements including time sections, material identifiers, and effect parameters in a machine-interpretable form.

The term “token sequence” refers to a series of discrete symbols representing parts of a natural language prompt sentence, obtained through a tokenization process and used as input to a generative artificial intelligence model.

The term “set of learned parameters” refers to numerical values within a machine learning model that have been trained on data and that determine how the model processes inputs and produces outputs.

The term “attention mechanism” refers to a computational technique used in a machine learning model that selectively weights contributions of different input tokens or internal states when generating an output, enabling the model to focus on relevant parts of the input.

The term “overall playback time” refers to a total duration of audiovisual content to be generated, measured as the time between the beginning and the end of the content.

The term “time section information” refers to data describing discrete temporal segments of audiovisual content, including at least start times, end times, and relative positions within the overall playback time.

The term “material identifiers” refers to data elements that uniquely identify respective audiovisual data items within a system, and that are used to reference those items in editing instruction data, internal editing plan data, and editing decision information.

The term “character information display information” refers to data specifying how, where, and when character information, such as text or symbols, is to be displayed within audiovisual content, including position, duration, style, and content of the displayed characters.

The server implements the claimed system as a network-accessible processing apparatus that cooperates with one or more terminals operated by users. The server includes at least one central processing unit, a main memory, a nonvolatile storage device, a network interface, and an operating system. The server executes a plurality of software modules including a web application module, an asset management module, a generative AI orchestration module, an editing plan generation module, an editing program control module, and an emotion analysis module.

The terminal is a general-purpose information processing terminal such as a smartphone, a tablet, or a personal computer. The terminal includes a processor, a memory, a display device, an audio output device, and a communication interface, and executes a web browser or native application that presents a user interface to the user. The user operates the terminal to upload audiovisual data and to input a natural language prompt sentence.

The user prepares raw audiovisual data such as video clips, still images, and audio recordings. The user also composes a prompt sentence that describes the desired structure and characteristics of an audiovisual content item. For example, the user may input the following prompt sentence via the terminal:

“Create a 60-second vertical promo video. Use ‘intro_clip.mp4’ for the first 8 seconds with the text ‘Welcome’. Then use ‘product_demo.mp4’ from 00:00 to 00:40 with three captions: ‘Easy Setup’, ‘Fast Performance’, ‘24/7 Support’. End with ‘outro_logo.png’ for 12 seconds and the text ‘Sign Up Today’. Add background music from ‘bgm_upbeat.mp3’ at medium volume.”

In another example, the user may input the following prompt sentence:

“Generate a 45-second vertical video for social media. Use my uploaded ‘coffee_shop_intro.mp4’ for the first 10 seconds with a title ‘Morning Coffee’. Then show close-up product shots from ‘beans_closeup.mp4’ for 20 seconds with overlay text describing the aroma and flavor. Finish with 15 seconds of ‘shop_exterior.mp4’ and a call-to-action text ‘Visit Us Today!’. Add background music from ‘bgm_soft_jazz.mp3’ at low volume.” The terminal transmits the audiovisual data and the prompt sentence to the server over a communication network via a secure protocol. The terminal sends the audiovisual data as media files and the prompt sentence as text data along with optional metadata such as target resolution, aspect ratio, and destination platform information.

The server stores the audiovisual data in a storage subsystem such as a redundant disk array or distributed object storage. The server generates and stores attribute information for the audiovisual data, including identifiers, file paths, duration values, frame rates, resolutions, and audio channel configurations. The server maintains these attributes in a structured data store such as a relational database or a key-value store, using normalized tables or structured documents.

The server executes the generative AI orchestration module to process the prompt sentence and the attribute information. The server employs a generative AI model that is implemented as a transformer-based neural network. The generative AI model includes an embedding layer that maps tokens of the prompt sentence to numerical vectors, multiple self-attention layers that compute weighted combinations of token representations, feedforward layers that apply nonlinear transformations, and output layers that map internal hidden states to structured editing instruction data. The generative AI model is configured as a sequence-to-structured-data model: it receives as input a sequence of tokens representing the prompt sentence and a serialized representation of the audiovisual attribute information, and it outputs a sequence of tokens that are parsed as structured editing instruction data.

The server trains the generative AI model in advance using supervised learning. The server supplies training data pairs consisting of natural language prompt sentences and corresponding ground-truth editing instruction data that encode timeline configurations, segment definitions, material identifiers, effect parameters, and text overlay specifications.

The server uses a loss function defined as a cross-entropy between the predicted token sequence and the ground-truth token sequence, and performs weight updates using gradient descent or a variant such as Adam. The server applies regularization and data augmentation techniques, such as random truncation, paraphrasing of prompt sentences, and perturbation of segment boundaries, to improve generalization and robustness. During training, the server stores learned parameters of the generative AI model in memory and optimizes them based on the loss function. As a result, the generative AI model internalizes patterns of mapping informal textual instructions to precise, machine-usable editing instructions.

The server, during inference, converts the prompt sentence into a token sequence by executing a tokenizer that segments the prompt sentence into subword units and maps each unit to an integer token identifier. The server also converts audiovisual attribute information into an auxiliary token sequence or feature vector representation, including normalized durations, identifiers, and supported resolutions. The server provides these token sequences as input to the generative AI model. The generative AI model computes self-attention scores between tokens, enabling the model to focus on portions of the prompt sentence that are relevant to particular timeline segments and materials. The model outputs a sequence of tokens representing structured editing instruction data, such as a list of segments, each with fields including a start time, an end time, a material identifier, a visual effect type, and an audio effect type.

The server parses the output token sequence into editing instruction data structured as a hierarchical data object. The editing instruction data is represented as an internal data structure such as a tree or nested list, where each node corresponds to a segment or effect.

The server verifies consistency of the editing instruction data, for example by checking that each referenced material identifier exists, that the sum of segment durations approximates the target duration specified in the prompt sentence, and that there are no invalid overlaps unless explicitly requested. If necessary, the server applies correction rules, such as scaling segment durations proportionally or adjusting overlapping segments based on precedence rules encoded in the editing plan generation module.

The server generates internal editing plan data by enriching the editing instruction data with low-level technical information derived from the audiovisual attribute data. The server resolves each material identifier to a file path and a timecode range within the corresponding file. The server converts time specifications from higher-level representations (such as “first 10 seconds” or “from 00:00 to 00:40”) into precise frame indices based on the frame rate of each video file. The server assigns each segment to one or more tracks (for example, a primary video track, a secondary overlay track, and one or more audio tracks), and encodes this assignment in track arrangement information.

The server then generates editing decision information, which represents a near-final set of instructions that describe, at frame-level or sub-second-level granularity, which segment is active in which track at each time position. The server stores the editing decision information in memory using an efficient data structure, such as an interval tree or segment list, to support fast conflict detection and time-based queries. This structure allows the server to quickly determine, for a given frame index, which clip and effect should be rendered. This data structure improves computational efficiency because it reduces the number of operations required to evaluate the editing plan when generating project data or when adjusting the plan based on emotion analysis.

The server converts the editing decision information into editing project data in a format recognizable by a specific editing program. In one embodiment, the server generates a project file in an extensible markup format representing a timeline with track elements, clip elements, transition elements, and text elements. In another embodiment, the server generates a project file in a proprietary interchange format defined by an editing software vendor. The project data includes absolute file paths, start and end frame indices, effect identifiers, parameter values such as transition durations and text styles, and layer indices. By constructing these project files automatically, the server eliminates the need for rule-based script writing for each individual project and reduces human error in creating complex timelines.

The server controls an editing program executing either on the same hardware node or on a dedicated rendering node. The editing program is a general-purpose video editing software capable of importing project data, assembling media clips, applying transitions and effects, and rendering the final audiovisual content. The server communicates with the editing program through an application programming interface, command-line interface, or scripting interface. The server instructs the editing program to load the generated project file, to resolve media references, and to perform automated rendering. During this process, the editing program performs low-level digital signal processing operations such as frame extraction, pixel-level composition, audio mixing, and codec-based encoding to create audiovisual content data in a predetermined format such as a compressed video file.

The server then generates access information for the audiovisual content data, such as a uniform resource locator or an identifier within a content delivery system. The server stores the content data and its associated access information in the storage subsystem and the database. The terminal retrieves the access information via the network and requests playback of the audiovisual content. The terminal downloads or streams the content using a standard streaming protocol and decodes and displays the content on the display device and audio output device. The user thereby views the generated content.

The server optionally acquires user emotion information as the user interacts with the generated content. The terminal may capture user reactions through camera-based facial expression analysis, microphone-based voice tone analysis, or explicit user input. The terminal transmits the user emotion information to the server. The server stores this information and processes it by executing the emotion analysis module. The emotion analysis module may include a separate neural network that maps features extracted from user signals (such as facial action units, prosodic features, or interaction patterns such as skip and replay events) to an emotion state vector representing intensities of emotions such as engagement, satisfaction, or confusion.

The server, based on the analysis result, modifies at least part of the editing instruction data or editing decision information. For instance, if the emotion analysis indicates that user engagement drops sharply during a particular time section, the server may shorten that section, alter transitions to be more dynamic, or emphasize specific materials by reordering segments. The server may feed the emotion analysis result back into the generative AI model as additional conditioning input, enabling the model to generate revised editing instruction data that is directly informed by user emotion states. The server thus closes a feedback loop: the server uses concrete, machine-interpretable emotion measures to computationally alter structural elements of the editing plan, rather than manually tweaking content.

This configuration yields several technical effects. Because the server represents editing plans as structured editing instruction data, internal editing plan data, and editing decision information with explicit time and track structures, the server can perform conflict detection, time alignment, and resource optimization in time proportional to the number of segments rather than the number of frames. This reduces computational complexity and accelerates the generation of project data, thereby increasing processing throughput. In addition, because the generative AI model directly outputs structured edit instructions rather than natural-language summaries or template identifiers, the system avoids intermediate heuristic parsing layers that are fragile and slow.

The server improves computational efficiency by integrating the generative AI model's structured output with the editing program's project format, so that the server can bypass manual user interfaces of the editing program and instead drive low-level engine functions via standardized data structures. This direct interface reduces overhead from repeated human interactions, minimizes user interface rendering on the editing node, and reduces communication traffic between nodes, resulting in faster rendering and lower latency from prompt to output.

The server further improves the accuracy and consistency of generated content structures. Because the generative AI model is trained with explicit attention to alignment between textual instructions and segment-level edit parameters, the model learns stable correspondences between expressions in the prompt sentence (such as “first 10 seconds with title” or “every 5 seconds alternate clips”) and concrete time boundaries and clip sequences. This trained mapping is not achievable by simple rule-based parsing, particularly when handling varied natural language expressions. The server thus reduces misinterpretations and temporal errors in the editing plan.

The server, by incorporating user emotion information into the internal data structures, introduces a nonconventional automated revision mechanism. Traditional manual editing relies on human intuition about viewer reactions, while this system codifies such reactions as numerical emotion vectors that directly influence edit plan regeneration. Because the emotion analysis result is used as a quantitative input to adjust edit durations, transition strengths, and effect parameters, the server can systematically converge toward versions of content that better maintain engagement, measured in objective computational terms. This is more than automating a human decision; it is a new computational control loop that uses emotion-derived signals to alter low-level media operations.

The server can be implemented in several alternative embodiments. In one embodiment, the generative AI model is a large transformer model running on a graphics processing unit with mixed-precision arithmetic and model parallelism to support large batch processing of prompt sentences and attribute information. In another embodiment, the generative AI model is a smaller model fine-tuned for specific content types, combined with a rule-based post-processing module that enforces domain-specific constraints such as maximum segment length or fixed positions of mandatory logos. In another embodiment, the server uses different project file formats depending on the target editing program, with a conversion layer that maps internal editing plan data to each supported format.

The terminal may be implemented as a browser-based client application that uses hypertext markup language, stylesheet language, and client-side scripting to display interactive editors for prompt sentences and asset selection. Alternatively, the terminal may be a native mobile application that integrates local media capture functions and offers direct uploading to the server. In each embodiment, the communication protocol between the terminal and the server is optimized to reduce data transfer volume, for example by compressing audiovisual data during upload and by using adaptive streaming for playback.

The user operates the system by providing audiovisual assets and prompt sentences and by optionally providing explicit feedback or allowing implicit emotion measurement while viewing rendered content. The user thus guides the overall creative direction, while the server performs the heavy computational tasks of interpreting the prompt, generating structured instructions, controlling the editing program, and optimizing the content based on emotion analysis.

Through these configurations, the system is not limited to an abstract manipulation of information; instead, the server executes concrete sequence-of-operations that directly control hardware resources such as network interfaces, storage devices, and processing units, as well as software components such as editing engines and neural network models. The server thus improves the functioning of the computer system by enabling a new mode of generating and refining audiovisual content with high speed, precision, and adaptability, which cannot be achieved by straightforward automation of human editing procedures.

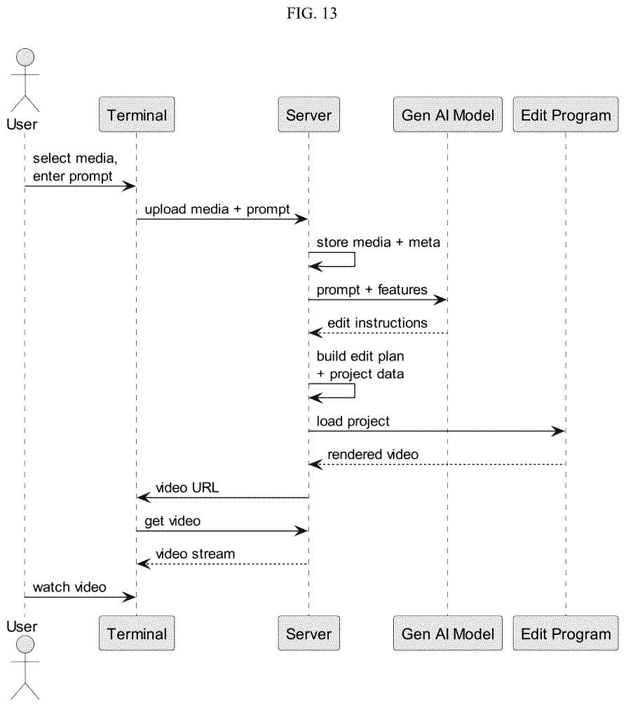

The following describes the processing flow using FIG. 13.

### Step 1:

The user prepares raw audiovisual data and a prompt sentence.

The user selects or captures video clips, still images, and audio recordings on the terminal and composes a natural language prompt sentence describing desired content structure, duration, and effects (for example, “Create a 60-second vertical promo video. Use ‘intro_clip.mp4’ for the first 8 seconds with the text ‘Welcome’. Then use ‘product_demo.mp4’ from 00:00 to 00:40 with three captions: ‘Easy Setup’, ‘Fast Performance’, ‘24/7 Support’. End with ‘outro_logo.png’ for 12 seconds and the text ‘Sign Up Today’. Add background music from ‘bgm_upbeat.mp3’ at medium volume.”). Input: user-created media files and a textual prompt sentence.

Output: a set of selected media files and a finalized prompt sentence ready for transmission.

### Step 2:

The terminal transmits audiovisual data and the prompt sentence to the server.

The terminal encodes the media files as binary data and the prompt sentence as text in a structured message (for example, a multipart HTTP request with JSON metadata). The terminal sends this message through a communication interface over a network.

Input: local media files and the prompt sentence on the terminal.

Output: an upload request containing binary media data and textual prompt data delivered to the server.

### Step 3:

The server receives and stores audiovisual data and associated metadata.

The server decodes the incoming request, writes each media file to a storage device, and generates attribute records (such as file path, duration, resolution, frame rate, and audio channel count) that are stored in a database. The server assigns a unique identifier to each media file and links this identifier to its attribute record.

Input: uploaded media data and metadata from the terminal.

Output: persisted media files in storage and structured attribute information in a database, each referenced by a unique identifier.

### Step 4:

The server registers the prompt sentence and content-generation settings.

The server parses the textual payload, extracts the prompt sentence, and stores it together with user-specified parameters such as target duration, aspect ratio, and distribution platform.

The server associates this prompt sentence and its parameters with the identifiers of the uploaded media assets.

Input: textual prompt sentence and associated configuration parameters.

Output: a stored prompt record linked to media asset identifiers and configuration parameters.

### Step 5:

The server preprocesses the prompt sentence and audiovisual attribute information for the generative AI model.

The server tokenizes the prompt sentence into subword units and maps them to token identifiers. The server converts audiovisual attribute information (such as clip durations and file types) into a normalized representation, for example as a sequence of auxiliary tokens or numerical feature vectors. The server bundles the tokenized prompt and the attribute representation into a structured input object for the generative AI model.

Input: stored prompt record and audiovisual attribute records.

Output: a model-ready input object containing a token sequence for the prompt sentence and structured feature data for media attributes.

### Step 6:

The server invokes the generative AI model to generate editing instruction data.

The server sends the model-ready input object to the generative AI model running on a processing device (for example, a GPU-enabled node). The generative AI model processes the token sequence and feature data through an embedding layer, multiple self-attention layers, and feedforward layers, and outputs a token sequence that encodes structured editing instructions. The server decodes this token sequence into a structured object that includes segments, segment start and end times, selected media identifiers, visual effect types, audio effect types, and text overlays.

Input: tokenized prompt sentence and normalized media attribute features.

Output: editing instruction data expressed as structured data (for example, a segment list with fields for time, material, and effect parameters).

### Step 7:

The server validates and normalizes the editing instruction data.

The server checks that all media identifiers referenced in the editing instruction data exist in the database and that time ranges do not exceed the durations of the corresponding media files. The server compares the sum of segment durations to the target duration in the prompt sentence and adjusts segment lengths proportionally if necessary. The server resolves overlaps based on predefined rules, such as keeping primary segments and trimming or shifting secondary segments.

Input: raw editing instruction data from the generative AI model and media attribute records. Output: validated and normalized editing instruction data that is consistent with media constraints and user-specified duration requirements.

### Step 8:

The server generates internal editing plan data linking instructions to precise media information.

The server resolves each segment's media identifier to an absolute file path and computes frame indices or precise timestamps based on each media file's frame rate or sample rate. The server assigns segments to specific tracks (for example, video track 1, video track 2, audio track 1) and encodes this mapping in a track layout structure. The server stores these details as internal editing plan data that augments each segment with file path, in/out frame indices, and track identifiers.

Input: validated editing instruction data and detailed media attribute records. Output: internal editing plan data specifying exact file paths, timecodes, and track assignments for all segments.

### Step 9:

The server constructs editing decision information from the internal editing plan data.

The server organizes segments in a time-indexed structure, such as an interval list or interval tree, to describe, for each segment, the active time interval on each track. The server computes derived data, such as total track lengths and points where transitions start and end.

The resulting editing decision information explicitly describes which segment and effect will be active for any given time point and track.

Input: internal editing plan data with segment, time, and track details.

Output: editing decision information that codifies a complete, conflict-resolved timeline and track arrangement.

### Step 10:

The server generates editing project data recognizable by an editing program.

The server maps the editing decision information into a project representation required by the selected editing program (for example, a timeline-based project file). For each segment, the server writes clip elements with file references, in/out times, and track indices, and for each transition and effect, the server writes corresponding elements with type identifiers and parameter values. The server serializes this project representation into a file using the editing program's defined format.

Input: editing decision information with time, track, and effect specifications. Output: editing project data in a program-specific file format that can be loaded by an editing program.

### Step 11:

The server controls the editing program to render audiovisual content data.

The server instructs the editing program to load the generated project file, to locate all referenced media files on the storage device, and to assemble the timeline. The editing program, under server control, performs low-level operations including frame extraction, video compositing, application of transitions, audio mixing, and encoding into a target container and codec. The server monitors the rendering process and collects status information until the editing program outputs a final media file.

Input: editing project data file and media files on storage.

Output: rendered audiovisual content data in a predetermined output format, stored on a storage device.

### Step 12:

The server generates access information and stores the rendered audiovisual content data.

The server assigns a unique content identifier to the rendered file, determines a storage location (for example, a file path or object storage key), and stores metadata such as duration, resolution, and encoding parameters. The server generates access information such as a network address or resource locator that can be used by terminals to request the content. The server registers this access information in the database linked to the user's project.

Input: rendered audiovisual content data file and rendering metadata.

Output: stored content data with associated access information and database records.

### Step 13:

The terminal requests and plays back the rendered audiovisual content.

The terminal retrieves the access information from the server, issues a content request (for example, an HTTP GET), and receives the audiovisual content data as a file or a stream. The terminal decodes the video and audio signals and presents them to the user through the display and audio output devices.

Input: access information for the rendered content and the user's playback request. Output: decoded and presented audiovisual content experienced by the user.

### Step 14:

The terminal collects user emotion information during or after playback.

The terminal optionally captures user reactions, for example by using a camera to record facial expressions, a microphone to capture voice characteristics, or user interface controls for explicit emotion ratings. The terminal converts these raw signals into digital emotion-related data and sends them to the server in a structured format.

Input: sensor data or manual input reflecting the user's emotional state.

Output: transmitted user emotion information suitable for analysis by the server.

### Step 15:

The server analyzes user emotion information and updates editing data.

The server processes the received emotion information using an emotion analysis algorithm that outputs an emotion state vector over time. The server aligns the emotion timeline with the content timeline and identifies time sections where engagement is low or negative emotion is high. Based on these analysis results, the server modifies editing instruction data or editing decision information, for example by shortening low-engagement segments, intensifying transitions, or reordering segments. The server then regenerates updated internal editing plan data and project data if necessary, enabling a new iteration of rendering.

Input: user emotion information and existing editing instruction and decision data.

Output: updated editing instruction data, editing decision information, and, optionally, new project data that reflect emotion-driven adjustments to the content structure.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional video authoring systems require a human editor to translate high-level creative intent (for example, desired length, mood, and storyline) into low-level editing operations such as shot selection, trimming, transitions, color grading, and audio mixing. Even where machine learning models are employed, such systems typically either: (i) perform isolated classification or recommendation on media items, or (ii) directly generate video in an end-to-end manner without exposing or controlling an intermediate representation of the edit plan. As a result, existing systems suffer from several technical limitations in terms of computer technology itself.

First, existing systems lack a unified internal representation that combines abstract requirement information, multi-modal analysis of motion image data, still image data, and audio data, and user emotion information into structured metadata and machine-readable editing constraints. Because of this, the system cannot efficiently compute optimal shot-level decisions under explicit time, theme, and mood constraints. This leads to sub-optimal use of computational resources, repeated ad-hoc inference calls, and difficulty in reusing analysis results across different generations or regenerations, thereby increasing processor load, memory access, and latency.

Second, in many systems that employ a generative AI model, the interface between the application logic and the model is limited to a simple natural language query. Such systems do not systematically construct a structured prompt sentence that encodes scene composition, shot selection policy, transition types, captioning, and audio usage policy in a manner that is consistent with pre-computed metadata and editing constraints. Consequently, the generative AI model cannot effectively leverage pre-analyzed visual and audio features, and the host computer cannot reliably steer the generative AI model to produce a machine-parsable editing scenario. This weak coupling results in less predictable outputs and requires additional post-processing steps, which further consumes processing resources.

Third, existing video generation implementations generally treat user emotion, if used at all, as a superficial filter applied at the end of the pipeline (for example, choosing one of several pre-defined templates). They do not integrate emotion analysis into the construction of the prompt sentence and into the generation and application of editing scenario data. Without such integration, the system cannot dynamically adjust shot selection, color tone, transitions, and audio selection based on a unified emotion profile derived from text, images, and audio.

This limits the system's ability to algorithmically adapt the entire editing pipeline to user emotion in a fine-grained, data-driven manner.

Fourth, traditional automated editing systems do not expose an explicit editing scenario data structure that is generated by a generative AI model and then deterministically executed by a separate editing engine. Instead, generation and rendering are entangled, which makes it difficult for the processor to perform deterministic timeline construction, verify time constraints, or incrementally regenerate parts of the video in response to user feedback. This entanglement increases computational overhead, reduces reuse of intermediate results, and complicates optimization of encoding and streaming workflows.

Accordingly, there is a need for an improved computer-implemented video generation system that: (i) systematically analyzes multi-modal media and abstract requirement information into structured metadata and editing condition information; (ii) constructs a detailed prompt sentence that encodes such metadata and conditions for a generative AI model; (iii) obtains, from the generative AI model, explicit editing scenario data that is machine-readable and executable; and (iv) integrates emotion analysis into both prompt generation and edit execution. Such a system should improve the efficiency, controllability, and predictability of the video generation pipeline at the level of computer architecture and processing flow, thereby reducing redundant computation, improving resource utilization, and enabling low-latency, high-quality generation of emotion-adaptive video content.

The specific processing by the specific processing unit 290 of the data processing device 12 in Application Example 2 is realized by the following means.

The present invention provides a server comprising a processor configured to receive motion image data, still image data, and audio data via an input unit, receive abstract requirement information including at least a requested playback time, a subject matter, an atmosphere, and a use purpose of target video content, execute natural language processing on the abstract requirement information to extract intent information and generate editing condition information, execute image analysis and scene segmentation on the motion image data and the still image data to generate structured shot-level metadata, execute audio analysis on the audio data to generate audio segment metadata, generate a prompt sentence in a text format that defines scene composition, shot selection, transition types, caption content, and audio usage policy based on the editing condition information and the generated metadata, provide the prompt sentence and at least part of the metadata as input to a generative AI model and acquire editing scenario data including sequence information, time information, shot reference information, and effect application information, select, cut, concatenate, and apply video effects and color correction to shots according to the editing scenario data, select and mix audio resources according to the editing scenario data and the audio segment metadata, estimate user emotion based on at least one of the abstract requirement information, the motion image data, the still image data, and the audio data by using an emotion analysis unit, adjust at least one of the prompt sentence, the editing scenario data application, shot selection, color tone, transition, and music selection based on emotion information estimated by the emotion analysis unit, and encode the edited video data and the edited audio data into container data according to a predetermined coding scheme. This enables the server to implement a technically improved video generation pipeline in which multi-modal analysis, structured metadata generation, prompt sentence construction, generative AI scenario generation, deterministic edit execution, and emotion-aware adjustment are tightly integrated, thereby reducing redundant computation, improving resource utilization and latency, and providing more predictable and controllable generation of emotion-adaptive video content.

The term “motion image data” refers to digital data representing time-varying visual content, including but not limited to video sequences composed of multiple frames, which can be decoded and processed as moving images by an information processing apparatus.

The term “still image data” refers to digital data representing a single visual frame or a plurality of independent visual frames, including but not limited to photographs, graphics, and illustrations, which do not inherently include temporal continuity between frames.

The term “audio data” refers to digital data representing sound information, including but not limited to speech, music, and ambient noise, which can be decoded and processed as an audio signal by an information processing apparatus.

The term “abstract requirement information” refers to high-level, user-provided information describing desired characteristics of target video content, including at least playback time, subject matter, atmosphere, and use purpose, which does not directly specify low-level editing operations.

The term “playback time” refers to a duration parameter included in the abstract requirement information, which designates a desired total time length of the target video content to be generated.

The term “subject matter” refers to a thematic or conceptual category specified in the abstract requirement information, such as a topic, event, or object to be emphasized in the target video content.

The term “atmosphere” refers to a qualitative indication of a desired mood or emotional tone for the target video content, including characteristics such as joyful, calm, nostalgic, or dramatic.

The term “use purpose” refers to a description of an intended usage scenario for the target video content, including but not limited to personal sharing, advertising, summary reporting, or archival recording.

The term “intent information” refers to structured data extracted from the abstract requirement information by natural language processing, which represents machine-interpretable parameters such as desired length, subject matter, atmosphere, pacing, and emphasis.

The term “editing condition information” refers to control information derived from the intent information and optionally from analysis results of the media data, which constrains or guides shot selection, scene arrangement, transitions, effects, and audio usage in the generation of the target video content.

The term “natural language processing” refers to a class of computational techniques that analyze and transform human-readable text into structured data, including at least tokenization, syntactic analysis, semantic interpretation, and intent extraction.

The term “image analysis” refers to processing applied to motion image data and still image data to extract visual features, including but not limited to object detection, face detection, expression analysis, color distribution analysis, motion estimation, and scene boundary detection.

The term “scene segmentation” refers to processing that divides motion image data into shots or segments by detecting changes in content or camera operation, such as cuts, fades, or substantial variations in visual features, in order to define unit segments for editing.

The term “feature quantities” refers to numerical or symbolic descriptors computed from media data, including but not limited to descriptors of objects, faces, expressions, motion magnitude, color tone, and acoustic properties, which are used to characterize and compare media segments.

The term “structured shot-level metadata” refers to structured data associated with individual shots or segments of motion image data and still image data, including identifiers, temporal boundaries, detected objects, faces, expressions, color attributes, and other feature quantities.

The term “audio segment metadata” refers to structured data associated with segments of audio data, including identifiers, temporal boundaries, classifications such as speech, music, or background sound, and feature quantities such as intensity, tempo, or spectral characteristics.

The term “prompt sentence” refers to a text-based instruction, created by the processor in a natural language format, that encodes editing condition information, scene composition policy, shot selection policy, transition types, caption content, and audio usage policy, and that is supplied as input to a generative AI model.

The term “generative AI model” refers to a computational model based on machine learning, including but not limited to deep learning models, which receives at least the prompt sentence and optionally metadata as input and outputs machine-readable data describing content or structure of video, such as an editing scenario.

The term “editing scenario data” refers to machine-readable data output from the generative AI model, including at least sequence information, time information, shot reference information, and effect application information that together define a timeline and operations for generating the target video content.

The term “sequence information” refers to information specifying an ordered arrangement of scenes or shots within the target video content, including at least relative or absolute ordering between segments.

The term “time information” refers to information specifying temporal positions and durations of scenes, shots, or effects within the target video content, including at least start times, end times, and overall length.

The term “shot reference information” refers to information that associates elements of the editing scenario data with particular shots or segments in the structured shot-level metadata, including identifiers or indices that enable retrieval and use of those shots.

The term “effect application information” refers to information included in the editing scenario data that specifies which video and audio effects, such as transitions, color adjustments, filters, and volume changes, are to be applied to specific shots, segments, or time ranges.

The term “video effects” refers to transformations applied to motion image data or still image data, including but not limited to transitions, overlays, filters, compositing operations, and graphic insertions that alter the visual appearance of the content.

The term “color correction” refers to processing applied to visual data to adjust color tone, brightness, contrast, saturation, or other color-related properties, including but not limited to grading operations used to achieve a desired visual atmosphere.

The term “volume adjustment” refers to processing applied to audio data to modify amplitude levels over time, including but not limited to gain control, normalization, and dynamic range compression.

The term “time adjustment” refers to processing applied to audio data to align or scale its duration relative to the video content, including but not limited to trimming, stretching, or looping operations.

The term “mixing processing” refers to processing that combines multiple audio signals, such as voice tracks, music tracks, and ambient sound tracks, into a single audio stream while controlling relative levels and timing.

The term “emotion analysis unit” refers to a functional module implemented by software, hardware, or a combination thereof, which estimates user emotion by analyzing at least one of text, motion image data, still image data, and audio data to output emotion information.

The term “emotion information” refers to structured data representing an estimated emotional state of a user, including at least a type of emotion, such as joy, sadness, excitement, or calmness, and optionally an intensity or confidence value.

The term “container data” refers to a coded data structure that multiplexes edited video data and edited audio data according to a predetermined container format, enabling storage, transmission, and playback of the target video content.

The term “predetermined coding scheme” refers to a predefined combination of coding methods and parameters used to encode video and audio data into the container data, including but not limited to a video compression standard, an audio compression standard, bit rates, resolutions, and frame rates.

The term “short-form video content” refers to target video content having a relatively short playback time specified in the abstract requirement information, typically on the order of several seconds to several minutes, which is intended for rapid consumption or distribution.

The term “time condition information” refers to information derived from the abstract requirement information that specifies constraints on duration of the target video content, including at least a desired total playback time and optionally allowable tolerance.

The term “candidate shot group” refers to a subset of shots selected from the structured shot-level metadata that jointly satisfy the time condition information and other constraints, and that are considered as candidates for inclusion in the final target video content.

The term “highlight degree” refers to a quantitative or qualitative measure assigned to each shot or segment that indicates its relative importance, interest level, or suitability as a highlight, as determined based on feature quantities, detected events, or user-related criteria.

The term “natural language processing model” refers to a machine learning model configured to process textual input and output structured information, such as tokens, semantic labels, or intent information, used to interpret the abstract requirement information.

The term “image analysis model” refers to a machine learning model configured to process visual input, such as frames of motion image data or still image data, and output structured information, such as detected objects, faces, or scene labels.

The term “machine learning technique” refers to a computational approach in which a model is trained on data to perform tasks such as classification, regression, or generation, including but not limited to techniques based on neural networks, statistical learning, or ensemble methods.

In one embodiment, a system includes a server and one or more terminals connected via a communication network. The server includes a processor, a main memory, a non-volatile storage device, a network interface controller, and at least one hardware accelerator such as a graphics processing unit. The processor executes programs stored in the non-volatile storage device and loaded into the main memory. These programs include modules for natural language processing, image analysis, audio analysis, emotion analysis, prompt sentence generation, interaction with a generative AI model, and video/audio editing and encoding.

The terminal includes a processor, a memory, a camera, a microphone, a display, and a communication interface. The terminal executes an application that allows a user to capture motion image data, still image data, and audio data, and to enter abstract requirement information for target video content. The terminal sends the captured data and the abstract requirement information to the server via a communication network using a structured protocol such as HTTP over TLS.

The user uses the terminal to record or select motion image data and still image data captured by the camera and to record audio data with the microphone. The user uses a graphical user interface on the terminal to input abstract requirement information including at least a requested playback time, a subject matter, an atmosphere, and a use purpose. Examples of such input are free-form text such as:

“Using the following video clips, create a 2-minute travel digest video. The theme is ‘adventure’, and please add energetic music.”

“Please create a nostalgic family-memory video under 3 minutes, using sepia tones and gentle plano music.”

“Create a video ad that highlights the main features of the new smartphone the user is interested in, with clear captions and upbeat music.”

The terminal converts this information into a structured request including media files and text, and transmits it to the server.

The server executes a natural language processing module implemented using a general deep learning framework and a sequence model architecture. In one embodiment, the server uses a bidirectional transformer-based language model having multiple self-attention layers, each layer including query, key, and value projections, multi-head attention, and position-wise feed-forward networks. The server tokenizes the abstract requirement information, applies the language model, and obtains contextual embeddings for each token. The server applies classification heads and span extraction layers on top of the embeddings to derive intent information such as desired playback time, subject matter, atmosphere, pacing preference, and emphasis targets. For example, the server converts “2-minute travel digest” into a numerical length constraint of 120 seconds, and converts “adventure” and “energetic music” into categorical labels for subject matter and atmosphere.

The server executes an image analysis module on motion image data and still image data using a convolutional neural network architecture or a hybrid architecture that includes convolutional layers and transformer-based attention layers. In one embodiment, the server uses a backbone network with multiple stages of convolution and pooling, followed by region proposal and classification layers to detect objects, faces, and salient regions. The server decodes motion image data into frames, computes frame-to-frame differences, and applies a scene boundary detection algorithm that uses histogram distance and motion vector statistics.

The server assigns scene boundary indices and segments the motion image data into shots.

The server computes feature quantities such as color histograms, optical flow magnitude, face presence, face expression scores, and frame composition scores for each shot. The server stores these feature quantities into structured shot-level metadata, which includes shot identifiers, temporal boundaries, and multi-dimensional feature vectors.

The server executes an audio analysis module on audio data using a neural network configured for audio classification and segmentation. In one embodiment, the server converts raw audio into a time-frequency representation such as a mel-spectrogram, and inputs the spectrogram into a convolutional or recurrent neural network. The server identifies speech segments, music segments, and background sound segments by applying classification heads over sliding windows. The server computes feature quantities such as tempo, average loudness, spectral centroid, and spectral flux for music segments. The server stores these results in audio segment metadata, including segment identifiers, time boundaries, labels (speech, music, ambient), and feature vectors.

The server executes an emotion analysis module that estimates user emotion based on at least one of text, images, and audio. For text, the server uses a classifier head on the transformer-based language model, trained with a loss function such as cross-entropy over emotion categories. For images, the server uses a convolutional neural network configured for facial expression recognition, taking as input cropped face regions extracted from frames and outputting probability distributions over emotion classes such as joy, sadness, anger, and surprise. For audio, the server uses a network that takes prosodic features (pitch contour, energy, speaking rate) and spectral features as input and outputs emotion labels. The server fuses the emotion outputs from these modalities using a weighted averaging or attention-based fusion network to obtain unified emotion information represented as a vector of emotion scores. This emotion information is stored as part of internal state associated with the request.

The server generates editing condition information from the intent information, shot-level metadata, audio segment metadata, and emotion information. This editing condition information is represented in a structured data format and contains constraints and policies such as target duration, minimum proportion of shots containing faces, preferred ranking of shots with high motion for an “adventure” theme, color tone preferences derived from emotion information, and audio style preferences. The server uses this editing condition information to construct a prompt sentence for a generative AI model.

The server constructs the prompt sentence in a natural language format so that the generative AI model can interpret it and generate editing scenario data. The server integrates into the prompt sentence the constraints extracted from the intent information, descriptions of available materials based on shot-level metadata and audio segment metadata, and emotion-based adjustments. For example, the server constructs a prompt sentence such as: “Using the user's travel video clips that contain smiling faces, outdoor adventure scenes, and city night views, create a 2-minute adventurous digest video. Use fast pacing, energetic background music, and focus on joyful and exciting moments. Include title text at the beginning and a closing scene with a sunset.”

In another example, the server constructs a prompt sentence:

“Based on the detected nostalgic emotion, create a 2-minute story-driven video using family photos and calm background music, with smooth cross-fades between scenes and a sepia color tone.”

The server supplies the prompt sentence and a compact representation of the shot-level metadata and audio segment metadata to a generative AI model. In one embodiment, the generative AI model is implemented as a transformer-based sequence generation model trained to output editing scenario data given prompt sentences and structured context. The model includes an encoder that processes the prompt sentence tokens and context tokens, and a decoder that outputs a sequence of editing commands. The training process uses supervised learning on pairs of prompt sentences and ground-truth editing timelines. The model uses a loss function such as cross-entropy over command tokens and time parameter bins. During training, the model parameters are updated using an optimization algorithm such as stochastic gradient descent with momentum or an adaptive variant, and the model is exposed to data augmentation techniques such as random reordering of non-critical commands and noise injection into time values, which improve robustness.

The generative AI model outputs editing scenario data in a machine-readable format that describes sequence information, time information, shot reference information, and effect application information. For example, the editing scenario data specifies that time 0-3 seconds uses shot S1 with a fade-in, time 3-7 seconds uses shot S5 with a hard cut from S1, time 7-10 seconds uses shot S9 with a cross-fade, and so on. It also specifies where to overlay title text, where to insert captions, and how to align music segments with visual segments.

The server interprets this editing scenario data using a deterministic editing engine. The server uses shot reference information to locate the corresponding shot entries in the structured shot-level metadata and their underlying media files. The server applies a scheduling algorithm that verifies that the total duration matches the requested playback time within an allowed tolerance. If the duration exceeds the constraint, the server truncates or compresses certain segments according to the editing condition information, such as dropping shots with lower highlight degree or shortening transition durations. This deterministic handling of the editing scenario data provides improved control and predictability compared to end-to-end generation approaches, thereby improving the reliability of the computer system.

The server performs video editing operations using a media processing library or equivalent low-level video processing routines. The server trims video clips and still images according to the start and end times specified in the editing scenario data. The server concatenates segments in temporal order, applies transitions such as fades and cross-fades by computing weighted averages of frames over transition intervals, and applies overlays and captions by blending graphic layers or text rendered into bitmaps with the video frames. The server performs color correction by applying transformations to pixel values such as gamma adjustment, brightness scaling, contrast adjustment, and color matrix multiplication, with parameters determined by the atmosphere and emotion information. For example, for a joyful atmosphere, the server increases saturation and brightness, while for a nostalgic atmosphere, the server applies a sepia-tone transformation that shifts colors towards warm tones and reduces saturation.

The server performs audio editing operations using an audio processing module. The server selects music segments based on the audio segment metadata and the editing scenario data.

The server applies time alignment so that changes in music intensity correspond to scene boundaries or emotional peaks. The server applies volume curves specified by the editing scenario data, such as fade-in at the beginning, ducking of background music during speech segments, and fade-out at the end. The server combines multiple audio signals by summing scaled samples, and applies dynamic range compression where necessary to avoid clipping and to maintain consistent perceived loudness across the video.

The server encodes the edited video and audio into container data using a predetermined coding scheme such as a standard video codec and a standard audio codec encapsulated in a container format. The server chooses encoding parameters such as resolution, frame rate, and bit rate based on the use purpose and network conditions. For example, for mobile short-form distribution, the server selects a moderate resolution and bit rate to reduce transmission size while preserving visual quality. The encoded container data is stored in a storage device and made available for streaming or downloading.

The server reduces redundant computation by separating analysis steps from generation steps and by storing structured shot-level metadata and audio segment metadata. When the user requests regeneration with different abstract requirement information, the server reuses the stored metadata and emotion information and only regenerates the prompt sentence and editing scenario data, followed by partial re-editing. This reduces the need to recompute expensive visual and audio features, improving processing speed and reducing energy consumption. The explicit internal data structures also allow the server to efficiently manage memory and bandwidth by only loading and processing media segments referenced by the editing scenario data.

The described architecture provides technical improvements over conventional systems. The use of structured shot-level metadata and audio segment metadata allows the server to perform optimized search and selection operations on precomputed feature vectors, which reduces the complexity of shot selection from scanning raw media to indexing over compact descriptors. The integration of a generative AI model that outputs editing scenario data rather than full video frames allows the server processor to offload creative planning to the model while retaining control over low-level rendering, which yields more predictable memory access patterns and simpler error handling. The emotion analysis integration into the prompt sentence and editing scenario adjustment enables the server to systematically modify visual and audio parameters based on quantitative emotion vectors, which can reduce user edits and re-renders, thereby saving computation.

The server uses training procedures that improve the accuracy and robustness of the generative AI model and the emotion analysis models. For example, the server trains the language model and image and audio models on large corpora of annotated examples, using regularization techniques such as dropout and weight decay to prevent overfitting. The server uses minibatch training with backpropagation to update model weights according to gradients of an objective function that combines classification loss and timing accuracy loss. The trained models thus produce more accurate intent information, shot labels, audio labels, and emotion information, leading to higher-quality editing condition information and editing scenario data.

The system is not limited to a single hardware configuration. In another embodiment, the server is implemented as a distributed computing cluster in which different nodes handle natural language processing, image analysis, audio analysis, emotion analysis, and editing operations. In such an embodiment, an orchestration module assigns tasks and aggregates results. In another variation, the generative AI model is hosted as a separate service accessible over a network, while the server performs local pre-processing and post-processing. In yet another embodiment, some preprocessing, such as downsampling of media or local emotion estimation based on facial expressions captured by the terminal, is performed on the terminal to reduce the communication load and the computational load on the server.

The terminal uses the generated video by displaying it on the display and by exposing user interface controls to share the video to external platforms or to provide feedback for regeneration. The user can indicate that the video should be “more emotional,” “shorter,” or “focus more on people,” and the terminal sends these instructions as updated abstract requirement information. The server interprets these instructions through the same natural language processing module, updates the editing condition information, and generates a new prompt sentence and editing scenario data without repeating the initial feature extraction on the media. This feedback loop provides a technical mechanism for iterative refinement while maintaining computational efficiency.

By providing a detailed internal data flow from media acquisition, multi-modal feature extraction, structured metadata creation, emotion estimation, prompt sentence generation, generative AI scenario generation, deterministic edit execution, and encoding, the system implements a specific technical process that improves the functioning of the computer as a video generation machine. The server uses specialized data structures and non-conventional processing sequences that are not used in ordinary text processing or manual editing workflows. These technical features produce concrete effects such as reduced processing time, reduced redundant computation, improved quality and consistency of generated videos, and reduced network load through optimized encoding and reuse of analysis results.

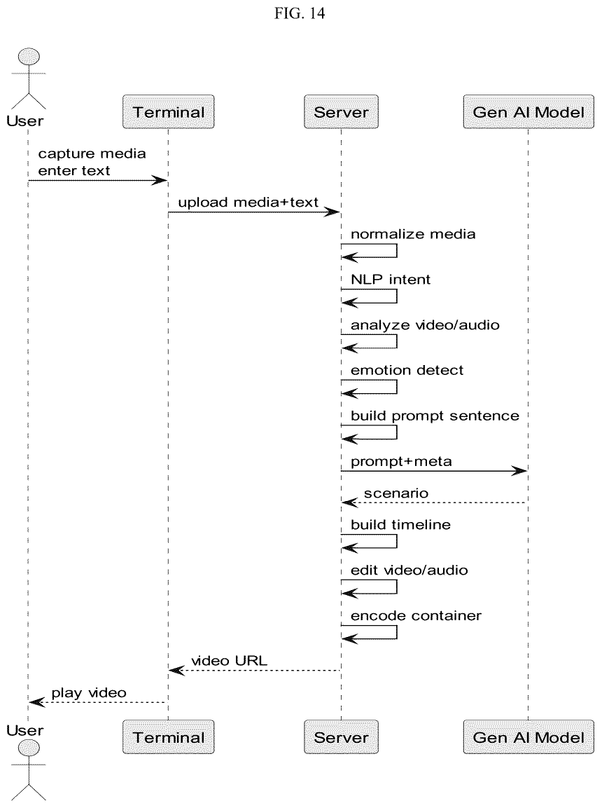

The following describes the processing flow using FIG. 14.

### Step 1:

User uses the terminal to capture and select media and to enter abstract requirements.

User records motion image data with the camera, still image data as photos, and audio data with the microphone, and selects existing files from local storage. User inputs abstract requirement information in text form, such as “Using the following video clips, create a 2-minute travel digest video. The theme is ‘adventure’, and please add energetic music.” Input: raw motion image data, still image data, audio data, and abstract requirement text entered on the terminal.

Output: a structured request object on the terminal including file references and the abstract requirement text.

### Step 2:

Terminal packages and transmits the request to the server.

Terminal reads the selected media files from local storage, serializes the abstract requirement information into a textual field, and constructs a network request using, for example, an HTTPS POST with multipart form data. Terminal attaches media files as binary parts and the abstract requirement text as a JSON or text field, then sends the request to the server's endpoint.

Input: structured request object (media file handles, abstract text).

Output: an HTTP request transmitted over the network to the server containing media bytes and requirement metadata.

### Step 3:

Server receives and normalizes the uploaded media.

Server accepts the HTTP request via the network interface, parses multipart boundaries, separates file parts from textual fields, and verifies file types and sizes. Server invokes a media processing tool or library to transcode unsupported formats into a standard format (for example, motion image data into a standardized codec, audio into a standardized codec, and still image data into a standard pixel format). Server stores normalized files into a storage device and records file paths and basic attributes such as duration and resolution in an internal database.

Input: HTTP request containing raw motion image data, still image data, audio data, and abstract requirement text.

Output: normalized media files stored on the server and a media index record containing identifiers, paths, durations, and resolutions.

### Step 4:

Server performs natural language processing on the abstract requirement information. Server feeds the abstract requirement text into a natural language processing module implemented as a transformer-based language model. Server tokenizes the text, maps tokens to embeddings, and performs contextual encoding. Server applies classifier heads to derive intent information such as requested playback time, subject matter, atmosphere, use purpose, pacing preference, and emphasis. Server converts detected expressions like “2-minute” into a numeric duration, and terms like “adventure” and “energetic music” into categorical labels.

Input: abstract requirement text and language model parameters.

Output: intent information represented as structured data, including fields for length, subject matter, atmosphere, and use purpose.

### Step 5:

Server analyzes motion image data and still image data to create shot-level metadata. Server decodes motion image data into frames using a video decoding library and computes frame differences and histogram distances to detect scene boundaries. Server segments the motion image data into shots using a threshold-based or learned classifier on the frame differences. Server processes representative frames or full frame sequences through an image analysis model (for example, a convolutional or hybrid network) to detect objects, faces, facial expressions, and salient regions, and to compute features such as color histograms and motion magnitude. Server assigns each shot a unique identifier, temporal boundaries, and a feature vector containing these quantities.

Input: normalized motion image data files, still image data files, and image analysis model parameters.

Output: structured shot-level metadata listing shot IDs, time intervals, and visual feature vectors for each shot or still image.

### Step 6:

Server analyzes audio data to create audio segment metadata.

Server decodes audio data into a waveform buffer and computes a time-frequency representation such as a mel-spectrogram. Server applies an audio classification network to classify time windows as speech, music, or background sound, and groups contiguous windows into segments. Server calculates acoustic features such as tempo, average loudness, spectral centroid, and spectral flux for each segment. Server assigns each segment a unique identifier, temporal boundaries, a label, and a feature vector.

Input: normalized audio data files and audio analysis model parameters.

Output: audio segment metadata listing segment IDs, time intervals, classification labels, and acoustic feature vectors.

### Step 7:

Server estimates user emotion from multi-modal inputs.

Server uses the intent information, and optionally image and audio features, to estimate a unified emotion profile. Server applies a text emotion classifier to the abstract requirement text, a facial expression recognition model to frames where faces are detected, and a voice emotion model to segments of speech. Server fuses these outputs by computing a weighted combination or by using a small fusion neural network, resulting in a multi-dimensional emotion vector with scores for categories such as joy, sadness, nostalgia, and excitement.

Input: abstract requirement text, shot-level metadata, audio segment metadata, and emotion analysis model parameters.

Output: emotion information represented as a vector of emotion categories and associated scores.

### Step 8:

Server generates editing condition information from analysis results.

Server combines the intent information, shot-level metadata, audio segment metadata, and emotion information to derive editing condition information. Server computes target duration constraints from the requested playback time, identifies preferred shot types based on subject matter (for example, shots with outdoor scenes and faces for travel), and sets style rules based on atmosphere and emotion (for example, bright colors and fast cuts for joyful, smooth transitions and sepia tones for nostalgic). Server formalizes these rules in a structured data object that specifies constraints and ranking policies for shot selection and audio selection.

Input: intent information, shot-level metadata, audio segment metadata, and emotion information.

Output: editing condition information containing duration, selection rules, ranking criteria, and style parameters.

### Step 9:

Server constructs a prompt sentence for the generative AI model.

Server converts the editing condition information and a summary of the available media into a natural language prompt sentence. Server composes text that describes the length, theme, atmosphere, preferred content types, and editing style, and references key properties of the shot-level metadata and audio segment metadata in descriptive form. Server may additionally refine this draft prompt sentence using an internal language generation module to ensure clarity and completeness.

Input: editing condition information and summarized media statistics.

Output: a prompt sentence expressed in natural language, suitable for input to a generative AI model.

### Step 10:

Server supplies the prompt sentence and context to the generative AI model and obtains editing scenario data.

Server encodes the prompt sentence and structured context (for example, a compressed representation of shot types and durations) into token sequences and feeds them into a generative AI model endpoint. The generative AI model processes the input using an encoder-decoder architecture and outputs a sequence of tokens that represent editing commands, including sequence ordering, time allocations, shot references, transitions, and effect instructions. Server decodes this output into an internal editing scenario data structure that lists timeline segments with corresponding operations.

Input: prompt sentence, compressed shot-level metadata, compressed audio segment metadata, and generative AI model parameters or service.

Output: editing scenario data including sequence information, time information, shot reference information, and effect application information.

### Step 11:

Server maps editing scenario data to actual shots and resolves timing.

Server parses each editing command in the editing scenario data and looks up the referenced shot IDs and audio segment IDs in the shot-level metadata and audio segment metadata. Server assembles a draft timeline by placing shots and audio segments at specified start and end times. Server checks whether the total video duration meets the duration constraint from the editing condition information, and if necessary, adjusts or prunes segments by removing lower-priority shots (for example, those with lower highlight degree) or shortening segments while preserving higher-priority content.

Input: editing scenario data, shot-level metadata, audio segment metadata, and editing condition information.

Output: a resolved editing timeline that specifies concrete media segments, exact times, and associated effects.

### Step 12:

Server performs video editing operations according to the resolved timeline.

Server reads the required portions of motion image data and still image data based on the resolved timeline and applies trimming to extract the specified time intervals. Server concatenates frames from different shots in timeline order. Server computes transitions such as fades and cross-fades by blending frames from adjacent shots according to alpha functions over the transition duration. Server overlays titles and captions at specified positions and times by rendering text to bitmaps and compositing them with video frames. Server adjusts color attributes of frames using the style parameters derived from emotion information, for example by altering brightness, contrast, and color matrices.

Input: resolved editing timeline and underlying media files.

Output: an intermediate edited video stream or sequence of frames representing the visual part of the target content.

### Step 13:

Server performs audio editing and mixing according to the resolved timeline.

Server selects audio segments identified in the timeline and loads the corresponding waveforms. Server aligns audio segments with the video segments by shifting or trimming waveforms to start and end at specified times. Server applies volume envelopes to each track, including fade-in, fade-out, and ducking patterns, based on the effect instructions in the editing scenario data. Server sums the waveforms of background music, speech, and ambient audio with appropriate scaling to prevent clipping and applies optional dynamic range compression.

Input: resolved editing timeline, audio segment metadata, and normalized audio data files.

Output: an edited audio stream synchronized with the edited video stream.

### Step 14:

Server encodes the edited video and audio into container data.

Server passes the edited video stream and edited audio stream to an encoder configured with a predetermined coding scheme. Server selects encoding parameters such as resolution, frame rate, bit rate, and codec profile based on the use purpose and possibly the network environment. Server performs compression to produce a combined container file that multiplexes the video and audio streams and writes container headers and indexes to enable efficient playback and seeking.

Input: edited video stream, edited audio stream, and encoding parameters.

Output: container data representing the final generated video content.

### Step 15:

Server returns a reference to the generated video content to the terminal.

Server stores the container data in a storage system and generates a unique identifier or URL for access. Server constructs a response message containing the identifier, URL, and basic metadata such as duration, resolution, and file size. Server sends this response back to the terminal over the network.

Input: container data and storage system state.

Output: a response to the terminal that includes a playback reference and metadata.

### Step 16:

Terminal retrieves and presents the generated video to the user and optionally collects feedback.

Terminal receives the playback reference from the server and initiates streaming or downloading of the container data using the provided URL. Terminal decodes the video and audio streams and displays the video on the display while playing the audio through the speakers. User watches the generated video and, if supported, enters feedback such as “make it shorter,” “use calmer music,” or “show more people.” Terminal packages this feedback as updated abstract requirement information and can send a new request to the server for regeneration, restarting the processing flow with reused analysis results on the server side.

Input: playback reference, container data, and user feedback.

Output: rendered video on the terminal and, if provided, a new feedback-based request sent to the server.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

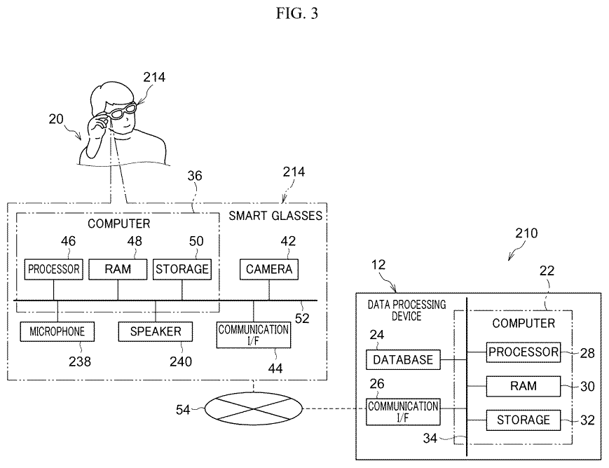

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

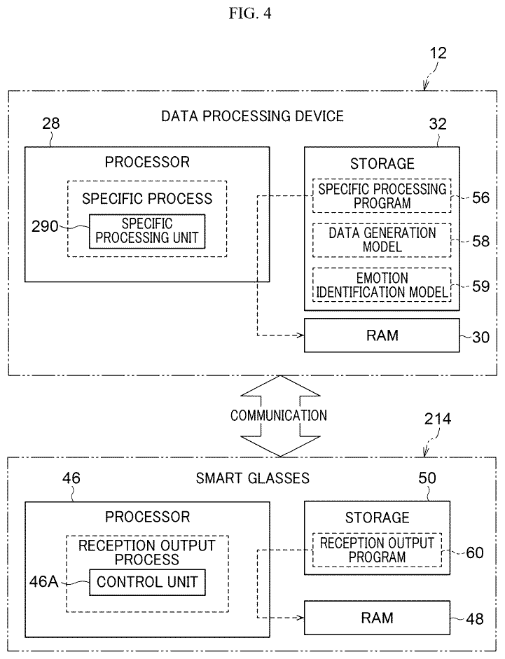

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network.

The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

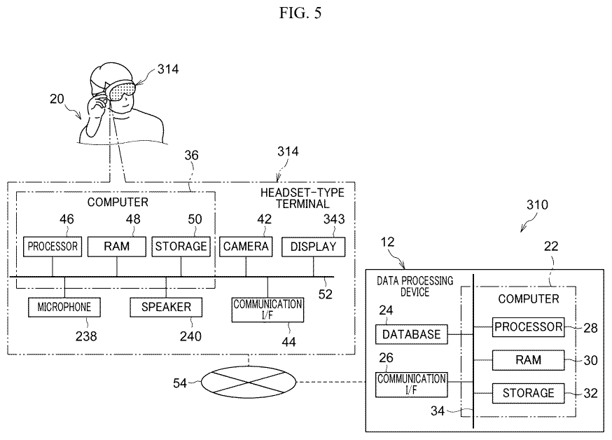

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

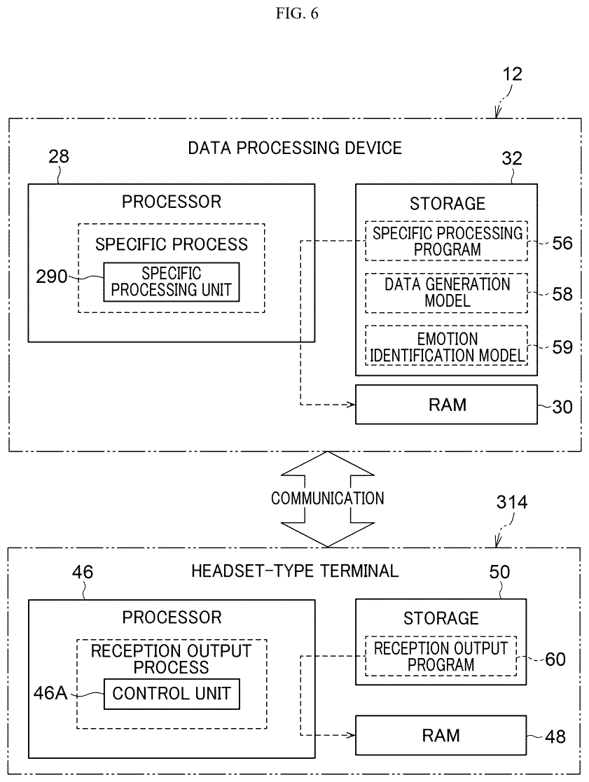

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

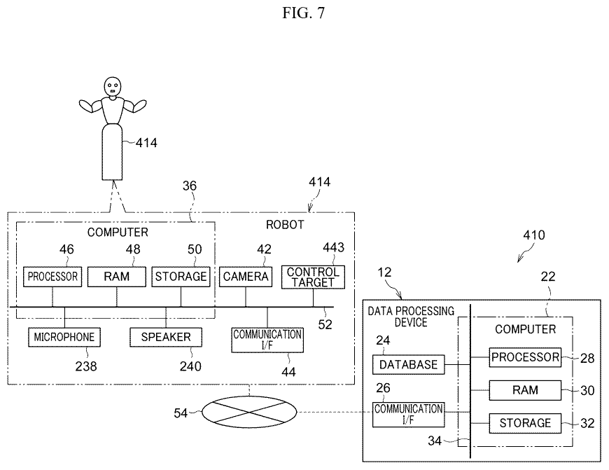

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

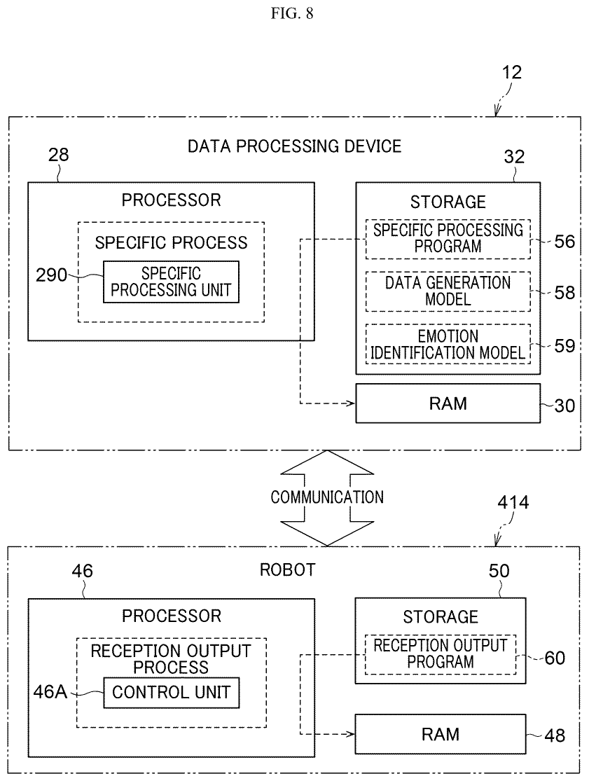

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

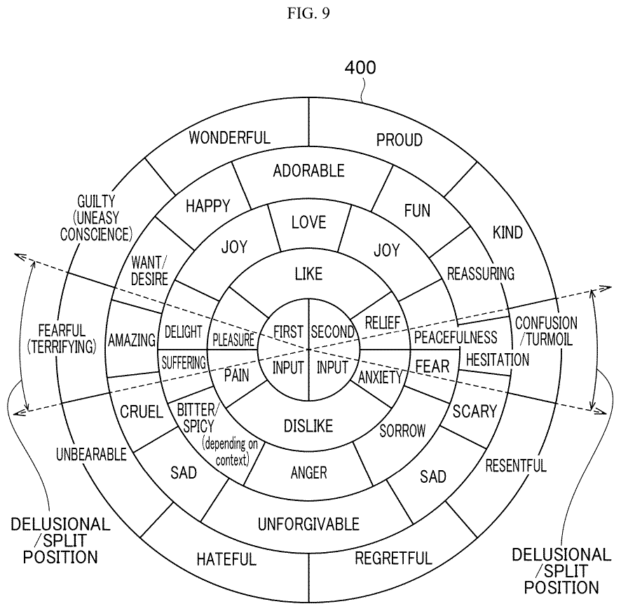

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University).

Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

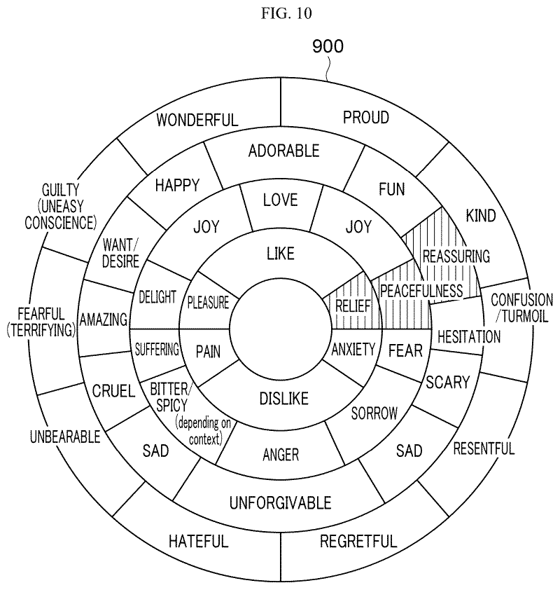

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
receive, via an input unit, visual information and auditory information including a plurality of types of time information, and store the visual information and the auditory information in a storage unit,
acquire, from a user, abstract feature information including at least a purpose, an atmosphere, a target duration, a set of focus scenes, and a set of publication conditions for a desired video, perform preprocessing on the visual information and the auditory information to extract time information, pixel information, acoustic information, and auxiliary information, convert at least part of the auditory information into character information, and integrate the abstract feature information and the extracted information into an internal representation suitable for machine-learning processing,
generate, based on the abstract feature information and the internal representation, an editing policy including at least a target playback duration, a set of scenes to be adopted, an editing order, a transition effect, a color adjustment, background sound, and a caption placement, and generate a prompt sentence including instruction content that reflects the editing policy for a generative artificial intelligence model,
cause the generative artificial intelligence model to execute inference processing by supplying the prompt sentence and the internal representation to the generative artificial intelligence model, and thereby cause the generative artificial intelligence model to automatically select, split, combine, process, and synthesize video content in accordance with the editing policy and output editing instruction information or composite video data, control, based on the editing instruction information, an image-signal processing unit to arrange the visual information and the auditory information on a time axis, apply transition effects, image-quality adjustments, and acoustic synthesis in accordance with the editing policy, and generate final video data,
estimate, by using at least one of biological information of the user, operation-history information of the user, and speech information of the user, an emotional state of the user, dynamically modify at least a part of the prompt sentence or the editing policy in accordance with the emotional state, and update a video-generation process performed by the generative artificial intelligence model, and
transmit the final video data to an external apparatus to enable playback, acquisition, and evaluation by the user.

### (Supplementary 2)

The system according to supplementary 1,
wherein the processor is configured to
when a generation request for a short-duration published video is estimated from the abstract feature information, analyze the time information and the character information obtained by the preprocessing, determine a configuration including at least candidates for high-importance scenes and structures of an introduction part, a main part, and an ending part such that a target playback duration is satisfied, and generate the prompt sentence that instructs the generative artificial intelligence model to perform scene selection and playback-time allocation in accordance with the determined configuration.

### (Supplementary 3)

The system according to supplementary 1,
wherein the processor is configured to
interpret the abstract feature information, the character information, and the emotional state via a natural-language processing unit using machine learning, reflect interpretation results in the prompt sentence as instruction content to be supplied to the generative artificial intelligence model, and control an automatic video-generation process performed by the generative artificial intelligence model based on the prompt sentence.

### Application Example 1

### (Supplementary 1)

A system comprising a processor,
wherein the processor is configured to
receive, by an information acquisition unit, moving image information, still image information, and audio information including unedited content as input materials, receive, by an information input unit, abstract request information from a user regarding a theme, a purpose, a mood, and a playback time of moving image information to be generated, execute, by a media pre-processing unit, format determination and capacity determination on the moving image information, the still image information, and the audio information, and perform conversion processing and compression processing on the moving image information, the still image information, and the audio information so as to unify the moving image information, the still image information, and the audio information into a predetermined encoding format and a predetermined resolution,
generate, by a prompt generation unit, text information defining the theme, the purpose, the mood, and the playback time of the moving image information to be generated on the basis of the abstract request information received by the information input unit, and format the text information into a structured prompt sentence serving as an instruction sentence to a generative AI model,
extract, by a feature generation unit, temporal information, pixel feature information, audio feature information, and feature information related to a scene type, a subject type, or an attention level from the moving image information, the still image information, and the audio information, perform text embedding processing for converting the text information included in the prompt sentence into a numerical representation, and construct the feature information and the numerical representation as input data for the generative AI model,
execute, by a generative model execution unit, the generative AI model using computation resources on the basis of the input data constructed by the feature generation unit, and output editing plan information including segment selection information for moving image sections, segment order information, screen transition effect information, text overlay information, and audio mixing parameter information,
convert, by a media editing unit, the editing plan information obtained by the generative model execution unit into editing instruction information, and perform trimming processing, concatenation processing, screen composition processing, screen effect processing, character information overlay processing, and audio synthesis processing on the moving image information, the still image information, and the audio information to generate moving image data in the predetermined encoding format,
acquire, by an emotion analysis unit, expression information, audio information, or operation history information related to the user, and estimate an emotional state of the user so as to detect the emotional state of the user,
dynamically change, by a dynamic adjustment unit, at least one of the prompt sentence, the editing plan information, and moving image generation processing in the media editing unit, on the basis of the emotional state estimated by the emotion analysis unit and an output of the generative AI model, and generate moving image data adapted to the emotional state of the user, and
provide, by a moving image providing unit, the generated moving image data to an information terminal via a communication path, and cause the information terminal to output the generated moving image data in a format that is capable of being reproduced or stored. (Supplementary 2)

The system according to supplementary 1,
wherein the processor is configured to, when the abstract request information acquired by the information input unit indicates that a purpose of publication of the moving image is short-time playback, cause the prompt generation unit to determine a target playback time on the basis of a total playback time calculated from the moving image information and the still image information, generate the prompt sentence including a condition for selecting candidate segments to be adopted based on the feature information extracted by the feature generation unit, and cause the generative model execution unit to execute the generative AI model so as to output the editing plan information that satisfies the target playback time and the condition regarding the candidate segments.

### (Supplementary 3)

The system according to supplementary 1,
wherein the processor is configured to cause the feature generation unit and the generative model execution unit to use a trained artificial intelligence model to interpret the moving image information, the still image information, the audio information, and the prompt sentence, generate the editing plan information that automatically determines a configuration, a composition, an editing order, and an expression style of the moving image by using the prompt sentence as the instruction sentence to the generative AI model, and cause the media editing unit to automatically generate the moving image data on the basis of the editing plan information.

### Example 2

### (Supplementary 1)

A system comprising a processor,
wherein the processor is configured to
receive pre-edit audiovisual data via an acquisition unit that acquires unedited video data, image data, and audio data,
receive information regarding audiovisual content to be generated via an acquisition unit that acquires information including a natural language prompt sentence describing desired characteristics of the audiovisual content to be generated,
control a generative artificial intelligence model so as to analyze the information including the natural language prompt sentence and attribute information regarding the audiovisual data, and output editing instruction data defining a timeline configuration, a used material for each time section, a start time and an end time for each time section, and visual and auditory effects,
convert the editing instruction data obtained from the generative artificial intelligence model into internal editing plan data, associate an identifier corresponding to the audiovisual data with storage location information in the internal editing plan data, and generate editing decision information including time information and track arrangement information for the audiovisual data,
generate editing project data recognizable by an editing program, based on the editing decision information, by disposing the audiovisual data on a time axis and generating data processing instructions including at least one of clipping processing, concatenation processing, scene transition processing, character information superimposition processing, and audio synthesis processing,
control the editing program using the editing project data so as to automatically execute digital signal processing including at least one of clipping processing, transition processing, character information rendering processing, and audio signal processing on the audiovisual data, and generate audiovisual content data in a predetermined format,
generate access information for the audiovisual content data and provide the audiovisual content data to an information processing terminal through a communication network, and acquire information regarding a user's emotion, analyze the acquired information using an emotion analysis algorithm, and modify at least a part of the editing instruction data or the editing decision information based on an analysis result of the emotion analysis algorithm so as to adjust content of the audiovisual content data.

### (Supplementary 2)

The system according to supplementary 1,
wherein the processor is configured to, in a case where distribution of short-duration audiovisual content is intended, extract, from the information regarding the audiovisual content to be generated including the natural language prompt sentence, information regarding a required playback time, constituent elements for each time section, and video cuts to be adopted, and cause the generative artificial intelligence model to generate the editing instruction data including an extraction result, thereby automatically determining a length of each time section and material placement in the editing decision information. (Supplementary 3)

The system according to supplementary 1,
wherein the processor is configured such that the generative artificial intelligence model encodes the natural language prompt sentence as a token sequence using a set of learned parameters having a natural language processing function, generates the editing instruction data as structured data through inference processing using an attention mechanism, and includes, in the structured data, at least overall playback time, time section information, material identifiers, start times and end times for each time section, visual effect information, auditory effect information, and character information display information.

### Application Example 2

### (Supplementary 1)

A system comprising a processor,
wherein the processor is configured to
receive, by an input unit, motion image data, still image data, and audio data obtained via a storage medium or a communication line,
receive, by an input unit, abstract requirement information including playback time, subject matter, atmosphere, and use purpose of target video content to be generated,
execute natural language processing on the abstract requirement information to extract intent information regarding length, subject matter, and atmosphere, and generate editing condition information based on the intent information,
execute image analysis processing and scene segmentation processing on the motion image data and the still image data to extract feature quantities indicating objects, facial expressions, motion, color tone, and scene boundaries, and generate structured shot-level metadata,
execute audio analysis processing on the audio data to extract feature quantities indicating speech sections, music sections, background sound sections, and music intensity, and generate audio segment metadata, generate, based on the editing condition information, the structured shot-level metadata, and the audio segment metadata, a prompt sentence in a text format that defines scene composition, shot selection, transition type, caption content, and audio usage policy of the target video content,
input the prompt sentence and the structured shot-level metadata into a generative AI model provided inside or outside the system, and acquire, from the generative AI model, editing scenario data including sequence information, time information, shot reference information, and effect application information for the target video content,
select, cut, and concatenate shots from the motion image data and the still image data according to the editing scenario data, and apply video effects and color correction to the selected shots,
select music data or audio data based on the editing scenario data and the audio segment metadata, and perform volume adjustment, time adjustment, and mixing processing on the selected music data or audio data, estimate a user emotion based on at least one of the abstract requirement information, the motion image data, the still image data, and the audio data by using an emotion analysis unit, adjust, based on emotion information estimated by the emotion analysis unit, at least one of the prompt sentence, the application of the editing scenario data, shot selection, color tone, transition, and music selection for the target video content, and
encode edited video data and edited audio data into container data according to a predetermined coding scheme and output the container data.

### (Supplementary 2)

The system according to supplementary 1,
wherein the processor is configured to, in a case where publication of short-form video content is requested, extract time condition information including a desired playback time from the abstract requirement information, select from the structured shot-level metadata a candidate shot group that satisfies the time condition information, prioritize shots having a higher highlight degree in the candidate shot group, include editing condition information reflecting the prioritization in the prompt sentence, cause the generative AI model to generate the short-form video content based on the prompt sentence, and generate the short-form video content according to the editing scenario data.

### (Supplementary 3)

The system according to supplementary 1,
wherein the processor is configured to use a natural language processing model and an image analysis model each constructed by a machine learning technique to interpret the abstract requirement information and the motion image data, still image data, and audio data, generate the prompt sentence including an interpretation result, input the prompt sentence into the generative AI model to obtain the editing scenario data, and automatically generate the target video content based on the editing scenario data.

What is claimed is:

1. A system comprising:
circuitry configured to:
receive, via a communication interface coupled to a packet-switched network, visual information and auditory information comprising a plurality of time-indexed media streams from a terminal device, and store the visual information and the auditory information in a storage device;
acquire abstract feature information from the terminal device via the communication interface, the abstract feature information comprising at least a target playback duration, an atmosphere parameter, a scene selection set, and a publication condition set for a desired output video;
perform preprocessing on the visual information and the auditory information to extract time information, pixel information, acoustic information, and auxiliary information, convert at least a portion of the auditory information into character information, and integrate the abstract feature information and the extracted information into an internal representation for machine-learning processing;
generate an editing policy based on the internal representation and the abstract feature information, the editing policy comprising at least a target playback duration value, a scene adoption set, an editing order, a transition effect set, a color adjustment parameter, a background sound parameter, and a caption placement parameter, and generate a prompt sentence encoding the editing policy as instruction content for a generative model;
supply the prompt sentence and the internal representation to the generative model via the communication interface to cause the generative model to output editing instruction information or composite video data, and control an image-signal processing unit based on the editing instruction information to arrange the visual information and the auditory information on a time axis, apply transition effects and color adjustments, and perform acoustic synthesis in accordance with the editing policy to generate final video data; and
estimate an emotional state of the user based on at least one of biological information, operation-history information, and speech information received from the terminal device, dynamically modify at least a portion of the prompt sentence or the editing policy based on the estimated emotional state, update video-generation processing performed by the generative model, and transmit the final video data to the terminal device via the communication interface.

2. The system according to claim 1, wherein performing preprocessing on the auditory information comprises applying a speech recognition model to convert the auditory information into character information, and wherein the character information is stored in the storage device in association with a time-index mapping that aligns each character sequence with a corresponding time position in the auditory information.

3. The system according to claim 2, wherein integrating the abstract feature information and the extracted information into the internal representation comprises concatenating feature vectors derived from the pixel information, the acoustic information, the character information, and the abstract feature information into a unified feature tensor.

4. The system according to claim 3, wherein generating the editing policy comprises inputting the unified feature tensor into a policy generation model stored in the storage device, and wherein the policy generation model outputs the editing policy as a structured parameter set.

5. The system according to claim 4, wherein the policy generation model is a machine learning model trained to minimize a reconstruction loss between generated policy parameter sets and ground-truth parameter sets derived from a training corpus of paired input media and reference video outputs.

6. The system according to claim 1, wherein generating the prompt sentence encoding the editing policy comprises mapping each parameter in the editing policy to a corresponding natural-language instruction token, concatenating the instruction tokens with a task description preamble, and appending a format specification that specifies the structure of the editing instruction information expected from the generative model.

7. The system according to claim 6, wherein the editing instruction information returned by the generative model comprises a sequence of editing operation records each specifying an operation type, a source segment identifier, a target time position, and optional effect parameters, and wherein controlling the image-signal processing unit comprises executing each editing operation record in sequence.

8. The system according to claim 1, wherein estimating the emotional state of the user comprises extracting feature vectors from the biological information, the operation-history information, and the speech information, and inputting the extracted feature vectors into an emotion estimation model stored in the storage device, the emotion estimation model outputting an emotion category label and an emotion intensity value.

9. The system according to claim 8, wherein dynamically modifying the prompt sentence based on the estimated emotional state comprises inserting an emotional tone modifier into the prompt sentence that directs the generative model to adjust an affective quality of the output video content based on the emotion category label.

10. The system according to claim 8, wherein dynamically modifying the editing policy based on the estimated emotional state comprises adjusting the atmosphere parameter in the editing policy based on a mapping between emotion category labels and atmosphere parameter values stored in the storage device.

11. The system according to claim 1, wherein the publication condition set specifies at least one of a target platform identifier, an aspect ratio, a maximum file size, and a codec specification, and wherein generating the final video data comprises applying encoding parameters derived from the publication condition set to the composite video data.

12. The system according to claim 11, wherein the circuitry is configured to generate a plurality of final video data variants by applying a respective set of encoding parameters for each target platform identifier in the publication condition set, and to store the plurality of variants in the storage device in association with respective platform identifiers.

13. The system according to claim 1, wherein the abstract feature information is acquired by receiving a natural-language description from the terminal device and parsing the natural-language description using a natural language processing model to extract the target playback duration, the atmosphere parameter, the scene selection set, and the publication condition set.

14. The system according to claim 13, wherein parsing the natural-language description comprises applying a named entity extraction step to identify time expressions for the target playback duration, applying a sentiment classification step to derive the atmosphere parameter, and applying a scene keyword extraction step to populate the scene selection set.

15. The system according to claim 1, wherein controlling the image-signal processing unit comprises transmitting the editing instruction information as a control signal sequence to a dedicated hardware accelerator, and wherein the hardware accelerator executes pixel-level blending, frame interpolation, and audio mixing operations in parallel to generate the final video data.

16. The system according to claim 1, wherein the circuitry is configured to receive an evaluation signal from the terminal device after transmitting the final video data, store the evaluation signal in the storage device in association with the prompt sentence and the editing policy, and use the stored evaluation signal as a training sample to fine-tune the policy generation model.

17. The system according to claim 16, wherein fine-tuning the policy generation model comprises computing a reward value from the evaluation signal, computing a policy gradient based on the reward value and the editing policy output by the policy generation model for the current input, and updating parameters of the policy generation model using the computed policy gradient.

18. A system comprising:
circuitry configured to:
receive, via a communication interface coupled to a packet-switched network, visual information and auditory information from a terminal device, and store the visual information and the auditory information in a storage device;
acquire abstract feature information from the terminal device comprising at least a target playback duration, an atmosphere parameter, a scene selection set, and a publication condition set, and perform preprocessing to extract pixel information, acoustic information, and character information from the visual information and the auditory information;
generate an editing policy based on the abstract feature information and the preprocessed information, generate a prompt sentence encoding the editing policy, supply the prompt sentence to a generative model via the communication interface, receive editing instruction information from the generative model, and control an image-signal processing unit based on the editing instruction information to generate final video data; and
estimate an emotional state of the user from biological information or speech information received from the terminal device, modify the prompt sentence or the editing policy based on the estimated emotional state, and transmit the final video data to the terminal device via the communication interface.

19. The system according to claim 18, wherein the circuitry is configured to receive an evaluation signal from the terminal device after transmitting the final video data, store the evaluation signal in the storage device in association with the prompt sentence and the editing policy, and use the stored evaluation signal as a training sample to update a policy generation model stored in the storage device.

20. A method comprising:
receiving, via a communication interface coupled to a packet-switched network, visual information and auditory information comprising a plurality of time-indexed media streams from a terminal device, and storing the visual information and the auditory information in a storage device;
acquiring abstract feature information from the terminal device via the communication interface, the abstract feature information comprising at least a target playback duration, an atmosphere parameter, a scene selection set, and a publication condition set for a desired output video;
performing preprocessing on the visual information and the auditory information to extract time information, pixel information, acoustic information, and auxiliary information, converting at least a portion of the auditory information into character information, and integrating the abstract feature information and the extracted information into an internal representation for machine-learning processing;
generating an editing policy based on the internal representation and the abstract feature information, the editing policy comprising at least a target playback duration value, a scene adoption set, an editing order, a transition effect set, a color adjustment parameter, a background sound parameter, and a caption placement parameter, and generating a prompt sentence encoding the editing policy as instruction content for a generative model;
supplying the prompt sentence and the internal representation to the generative model via the communication interface to cause the generative model to output editing instruction information or composite video data, and controlling an image-signal processing unit based on the editing instruction information to arrange the visual information and the auditory information on a time axis, apply transition effects and color adjustments, and perform acoustic synthesis in accordance with the editing policy to generate final video data; and
estimating an emotional state of the user based on at least one of biological information, operation-history information, and speech information received from the terminal device, dynamically modifying at least a portion of the prompt sentence or the editing policy based on the estimated emotional state, updating video-generation processing performed by the generative model, and transmitting the final video data to the terminal device via the communication interface.
